(19) United States
(12) Patent Application Publication
(10) Pub. No.: US 2002/0169658 A1
(43) Pub. Date: Nov. 14, 2002

(54) System and method for modeling and analyzing strategic business decisions

(76) Inventor: Richard M. Adler, Winchester, MA (US)

Correspondence Address: Kevin M. Drucker, HAYES SOLOWAY P.C., 130 W. Cushing Street, Tucson, AZ, 85701, US

(21) Appl. No.: 10/091,859

(22) Filed: Mar. 6, 2002

Related U.S. Application Data
(60) Provisional application No. 60/274,328, filed on Mar. 8, 2001.

(51) Int. Cl. G06F 17/60

(52) U.S. Cl. 705/10

(57) ABSTRACT

A set of modeling and analysis tools is provided to help companies make informed strategic decisions in complex, rapidly changing market environments. Outcomes of candidate decisions are simulated over time, under different evolutionary scenarios that reflect assumptions about trends in a market and the overall economy, and the likely behavior of individual businesses. Detailed analyses are then generated, both qualitative and quantitative, of the different outcomes, helping users to identify the decision option with the most attractive rewards and tolerable risks. Users may revisit prior decisions, by periodically updating models with current market data and refining behavioral assumptions based on observations. Users can then re-run the simulations and analyses to determine if decisions remain valid and optimal, or whether circumstances have changed sufficiently to warrant modifying initial strategies. Applications include supporting strategic decision-making pertaining to business issues such as B2B channel strategies, mergers & acquisitions, creating (or dropping) products, business units, or production capacity, and to strategic decision making in military, legislative, healthcare, environmental, political, and other non-business domains.

The present application claims priority to Provisional Application Serial No. 60/274,328, filed Mar. 8, 2001.

### BACKGROUND OF THE INVENTION

The present invention relates generally to a software-based system and method for modeling and analyzing complex strategic decisions. The invention has particular utility with respect to modeling and analyzing complex strategic business decisions, such as building vs. joining electronic marketplaces, or evaluating merger & acquisition opportunities, and will be described principally in connection with such utility, although other utilities are contemplated. More particularly, the system and method provide frameworks for: collecting data pertaining to key decision factors; for simulating the outcomes of decision options under various scenarios about the future; and for systematically assessing the likely risks and rewards of those alternatives to identify the most promising strategy to pursue.

Businesses face decisions about their strategies on a recurring basis. A decision is strategic if it defines, maintains, or changes a company's mission, market scope, and/or market differentiation. A mission encompasses a company's goals and objectives, and defines the value proposition the company offers to prospective buyers and partners. Market scope refers to the collection of goods and services a company sells to particular groups of buyers (as well as excluding market segments in which the business chooses not to compete). Finally, market differentiation pertains to how the company distinguishes itself from its competitors with respect to cost, innovation, and service. Differentiation also delineates the ways in which a company structures itself, and defines and organizes the business activities required to achieve its mission. See, e.g., Michael Porter, “What is Strategy,” Harvard Business Review, Nov-Dec. 1996, pp.61-78; Gary Hamel, Leading the Revolution, HBS Press, Cambridge, Mass., 2000.

Examples of strategic choices include making decisions about: creating or participating in new sales channels such as on-line electronic marketplaces; entering a new line of business or building new products or production capacity; and changing market profiles by selling a line of business, merging with another company, or acquiring another company or company unit.

Strategic business decisions typically involve complex trade-offs involving factors such as market positioning, finance, technology, corporate culture, employee and consumer psychology, and regulations. Analyzing these trade-offs is complicated by the fact that they are contingent upon numerous assumptions about the current and future business environment. Few dedicated analytical tools and methodologies exist to help companies explore and assess their decision options at levels of breadth and detail commensurate with the relevant business risks and rewards entailed by these choices.

(This situation contrasts with the emergence of dedicated commercial tools to help companies make specific operational or tactical decisions about: managing supply chains (supply and demand, inventory, logistics); optimizing product mix, prices, and markdowns; and about analyzing return on investment (ROI) for adopting enterprise information technology products, such as document management systems or PC upgrades. However, these tools target non-strategic decisions bounded by short time horizons, purely internal business scope, or other significant restrictions on complexity that permit the application of conventional approaches such as operations research algorithms or standardized spreadsheet models and report generators.)

The absence of predefined tools forces most businesses facing strategic decisions to proceed on a more or less ad hoc basis. Decision methodologies tend to be informal and one of a kind, unless the type of decision is a recurring one for the company or decision-makers have formal training in strategic planning, The general approach is to perform market research, collecting analyst reports, government statistics, and perhaps conduct surveys to gain some insight into current conditions and possible trends. Planners formulate strategic options, identify decision factors, and apply market data to try to understand the situation and its implications. At best, mediated group discussions, using techniques such as the Delphi method, may be used to encourage thoroughness and a structured, systematic process. Databases and spreadsheet models may be constructed on a custom basis to help aggregate relevant data and decision factors, and to project the implications of decision options given different assumptions. However, these tools limit most users to simple quantitative models, generally confined to financial issues, which project sales growth, profits, ROI, payback periods, etc. More sophisticated firms may employ analytical tools such as decision trees, which enable users to represent and manage not only quantitative decision criteria and their relative weights, but also to try to factor causal relationships or other dependencies into the analysis. However, most firms lack the resources, time, and expertise to develop, validate, and maintain such methods and tools over time to ensure a consistent, repeatable process

More seriously, conventional decision support tools such as spreadsheets and decision trees fall far short of meeting actual business requirements for making considered strategic decisions about sales channels, mergers & acquisitions, and the like. Several key problems can be identified.

First, commercial decision support tools tend to be generic and neutral with respect to domain content. Thus, the burden of formulating strategic options and decision factors, gathering, maintaining, and transforming the relevant data, and performing detailed analytic trade-offs falls on a company's planners, analysts, or outside consultants. This exposes companies to risks of cost, effort, time, expertise, and ultimately decision quality.

Second, conventional decision support tools are based on linear problem-solving methods, and have difficulty representing situations where interactions are multiplicative rather than purely additive. (A non-linear function is one that cannot be expressed as the sum of factors multiplied by constants, such as X=c1*v1+c2*v2+ . . . , where cᵢ and vᵢ represent fixed numbers and values of independent variables.) Strategic decisions increasingly relate to rapidly changing markets and new “disruptive” technologies, which exhibit non-linear phenomena such as “network effects” and “early-mover” advantages. A network effect, common with communication-centric products such as fax machines and telephones, is a situation where the value to participants increases exponentially with the number of possible adopters and interconnections. An early-mover advantage accrues to the first few providers of a good or service, who realize accelerating market position and/or cost advantages either due to network adoption effects, or because they advance faster along (non-linear) learning curves for producing and enhancing their offerings efficiently. See, e.g., Kevin Kelley, New Rules for the New Economy: 10 Radical Strategies for a Connected World, Penguin Group, NY, 1998; Donald Tapscott, David Ticoll, Alex Lowy, Digital Capital: Harnessing the Power of Business Webs, HBS Press, Cambridge, Mass., 2000). Standard modeling techniques based on linear approximations are inadequate in these contexts.

Third, conventional decision support tools tend to be overwhelmed by the large numbers of entities engaging in multiple simultaneous interactions with one another, often via different (non-linear) mechanisms or pathways. Difficulties that arise in predicting aggregate behavior in the face of this diversity are both computational and representational. Representational difficulties refer to problems of capturing and managing all of the relevant conditions, factors and forces, qualitative as well as quantitative, at play in a given decision domain.

A corollary problem for most decision support tools is that they lack an object-oriented abstraction: spreadsheet cells, and parameters in decision tree and simulation tools consist of isolated values that have no intrinsic relationships—they are simply independent values coupled together by formulas. This precludes exploitation of object-oriented language features to manage complexity such as inheritance, encapsulation, polymorphism, which promote reuse, modularity, adaptation, and dynamic behavioral bindings. See, e.g., James Rumbaugh, Michael Blaha, et al. Object-Oriented Modeling and Design, Prentice-Hall, Englewood Cliffs, N.J., 1991.

Fourth, as a consequence of the linearity and scalability restrictions, conventional decision support tools focus on aggregated assumptions, leading to the well-known “GIGO” critique of spreadsheets—garbage in, garbage out. Thus, an ROI model can extrapolate the financial projections of an assumed pattern of sales growth, but it cannot explore the market dynamics—model the interactions and decisions of the individual businesses within the relevant market segment—required to assess the actual plausibility of achieving the assumed sales growth.

Fifth, and perhaps most important, markets are dynamic rather than static systems. Strategic decisions must reflect not only situations as they exist at a given point in time, but also conditions and relationships as they may exist in the future. Thus, it is insufficient to simply capture how decision factors relate to one another today. What is vital for sound decision-making is to understand how those factors will evolve, be weighted, and inter-related over time. It is also critical to try to anticipate discontinuous changes in the environment, brought about not only by non-linear effects but also by the occurrence of singular events, such as wars, natural disasters, material shortages, recessions, etc. Conventional tools are poorly suited for modeling singular events and their impact, particularly for non-expert users.

Sixth, markets are not simply dynamic, but also adaptive systems: individual businesses are active and autonomous entities rather than passive participants. As such, they monitor their environment and their success or failure and modify their behaviors to improve performance. Companies act both defensively, to match competitors' products or capabilities, and offensively, to try to seize advantage that is hopefully sustainable. Businesses in most markets may also have to respond to government regulatory bodies, which may impose legislative rules or intervene to correct perceived inequities or compliance problems, altering the ambient “boundary conditions” that constrain business behaviors. Conventional tools, lacking object abstractions and focusing on financial attributes, are incapable of capturing or manipulating these key behavioral aspects of the market environments in which decisions must be made.

In sum, complexity in strategic decision-making about markets arises out of diversity, non-linearity, dynamics, disruptive events, and adaptive behaviors.

A need exists for comprehensive analytic tools that address these complexities and replace current approaches that force businesses to rely on inherently inadequate fragmentary analyses and “gut instincts” in setting corporate direction. What is needed is an analytic capability analogous to taking a new car for a test drive. Researching car features and price is insufficient to ensure satisfaction: consumers need to drive vehicles to verify comfort, the feel of the ride, storage space, controls, etc. before they are willing to commit to major purchases. Businesses need analogous capabilities to conduct virtual test drives for their strategic decisions—a means of exploring the consequences of their options in a concrete and detailed manner, prior to making significant, often irreversible capital investments and market exposures.

### BACKGROUND OF ONE EMBODIMENT OF THE INVENTION

One embodiment of the invention focuses on decisions involving online Business-to-Business (B2B) marketplaces. Internet-based marketplaces represent a rapidly growing electronic commerce channel for trading goods and services. B2B marketplaces focus on mediating trading between businesses over the Internet, as contrasted with retail Business-To-Consumer (B2C) venues such as Amazon.com™.

B2B marketplaces are essentially on-line intermediaries that seek to replace or subsume the roles played by traditional “middlemen” such as brokers, agents, and distributors in economic markets. These traditional “third parties” provide value to customers by simplifying the task of locating suitable goods or trading partners, reducing costs, or otherwise improving commerce for their clientele. Brokers, for example, leverage superior knowledge of supply, demand, and market prices to reduce the costs of finding and qualifying trading partners for clients that buy and sell products in “fragmented” industries. (An industry that is fragmented typically contains large numbers of small buyers and/or sellers, often highly distributed geographically. This results in high “search” costs, which are the expenses that businesses incur to locate and qualify companies that buy or sell the goods and services they need.) Distributors, similarly, provide business value to both buyers and sellers by: maintaining inventories of products; providing expert knowledge on selecting and using complex products (e.g., chemicals, fasteners, components); and providing custom assembly, integration, installation and possibly follow-on maintenance and support services. By focusing on these shared functions and amortizing them across the market, traditional middlemen reduce overhead expenses for vendors and buyers such as carrying costs, availability lead times, in-house expertise, and customized support.

Internet-based marketplaces compete with traditional intermediaries by defining alternative Internet-based channels that create new market efficiencies and value-added services. They typically make vendor and pricing information readily available or “transparent,” eliminating brokers' ability to charge for preferential market knowledge. These “Emarketplaces” offer alternative value to business customers via offerings such as transaction engines, “infomediary” services, on-line communities, and integration with third-party service providers and members' back-end information systems.

Transaction engines are secure and reliable e-business software applications for executing on-line, real-time trading processes between buyers and sellers, including auctions, bid-ask exchanges (like NASDAQ™), negotiations, and automated requests for proposal or quotation. “Infomediary” services promote information aggregation and sharing. Examples include consolidating general business and industry-specific news feeds, statistics, and prices, and providing members with capabilities to publish, maintain, and disseminate product catalogs, data sheets, and marketing collateral. Communities provide public discussion or “chat” groups, event calendars, job and resume bulletin boards, etc.

Integration with third-party providers enables marketplaces to offer pre-packaged services to members from specialists in automating business activities surrounding on-line purchases including credit-checking, billing and payment, cross-business collaboration on design and marketing, fulfillment and delivery logistics (preparing goods, selecting and scheduling carriers, shipment, verification, and order management). Integration with member back-end systems helps automate B2B trades and enables trading partners to selectively exchange supply chain information such as prices, inventory, and availability, using the Emarketplace and its Internet-based application software as the shared communications infrastructure. (Prior to the Internet, such connectivity required costly leased telephone lines and third-party communication networks that were generally only practical for large companies.)

Internet-based marketplaces are a relatively recent business innovation, leveraging Internet communication infrastructure to create new electronic business channels. Most electronic marketplaces have only existed for a few years at most. Not surprisingly, the business models for such entities are diverse, evolving rapidly, and competing with one another. B2B exchanges are open marketplaces, which invite participation of any (qualified, trustworthy) business that seeks to buy or sell relevant goods or services or share supply chain information selectively with its partners. Exchanges are often owned and operated by consortia of industry leaders (e.g., GM, Ford, Daimler-Chrysler backing Covisint). Private marketplaces, in contrast with exchanges, restrict membership to specific businesses. Very large companies (Cisco, Intel, Dell) often use private marketplaces sites to leverage their size, and to control their purchasing and sales channels. Typically, the founding company promotes competition among its suppliers, but precludes competition with respect to the goods that it sells to others. Private marketplace owners often allocate space and services to partners, such as distributors who participate in their sales channels and vendor partners that sell complementary products. Exchanges, with less restrictive membership policies on buyers and sellers, promote more symmetrical trading. Consortia-backed exchanges tend to focus at least as much on information system integration and supply chain collaboration as on competitive pricing.

Alternative models for Emarketplaces include net markets, trading hubs, and auction outsourcers. Net markets are typically started by independent players in an industry and generally focused on “spot markets,” trading of products prone to surplus availability or shortages using dynamic market pricing schemes such as auctions. Community-based markets are markets in which an independent company builds and operates a collection of distinct, but interoperating EMarketplaces on a common technology platform. Trading networks, or “e-hubs,” provide a utility-like model in which companies trade products across many industries in a common marketplace setting. Outsourced trading services are services whereby businesses contract with third-party companies that conduct on-line auctions, reverse auctions, or request for proposal processes for specific purchases (or sales).

Business benefits to participants in Internet-based markets vary by market roles and across different B2B marketplace models. The following examples are representative. Potential benefits for companies that buy through B2B EMarketplaces include: (1) access to more suppliers, including smaller and potentially global sources; (2) significant reduction in cost of goods purchased, realized from transactional efficiencies introduced by on-line capabilities to obtain product information, locate suitable trading partners, arrange logistics, and resolve problems; (3) improved pricing through competitive bidding mechanisms such as RFPs, RFQs, and reverse auctions; (4) shorter negotiation cycles with suppliers; (5) additional sourcing capability for hard to find and discounted items from surplus or excess inventory; (6) optimized purchasing from more accurate demand and supply information; and (6) improved understanding of overall market behavior and trends (obtained by buying and analyzing aggregated trading data). Potential benefits for companies that sell via B2B marketplaces include: (1) expanding and exploiting new sales channels (particularly important for smaller vendors); (2) reaching new buyers who are not under contract, potentially in global markets; (3) increasing profits and improved margins, realized from transactional efficiencies introduced by on-line dissemination of product information, customer self-service for sales and support; (4) competitive pricing models such as forward auctions, and increased sales volume; (5) improved management of inventory and production capacity, from improved knowledge of customer demand and new on-line channels for selling surplus, excess, discontinued, and damaged goods more easily; (6) channels to test new product pricing; and (7) improved understanding of overall market behavior and trends (obtained by buying and analyzing aggregated trading data).

Trading via Internet-based marketplaces promises significant competitive advantages, including reduced costs, opportunities for revenue growth, competitive pricing, and enhanced decision-making based on better market visibility. Consequently, B2B exchanges and other electronic marketplace variants are emerging as important, potentially dominant channels for trading goods and services. Analyst consensus is that B2B marketplaces will exceed one trillion dollars in trade volume over the next few years. As a consequence, businesses face key strategic decisions on positioning themselves to respond effectively to this major environmental trend.

Specific options for developing B2B channels may include building and operating private marketplaces; joining one or more private EMarketplaces or public exchanges; collaborating with other companies to develop exchanges under joint ownership; and/or composite strategies that combine one or more of the previous approaches. Composite strategies may be quite complex. A business may stage a sequence of initiatives over time, for example, by joining an existing EMarketplace to gain experience and then staking out a more aggressive stance by developing or co-developing a private marketplace. Alternatively, a business may define and pursue several strategies simultaneously, in conjunction with existing, conventional business channels such as catalogs, distributors, retail partners, etc. Large corporations may adopt different strategies across different divisions, which operate in different markets and have differing competitive positions. Strategic decisions are further complicated by the variety of B2B marketplace models described above. Once one or more candidate models has been selected, build/join decisions must specify what services must be offered or utilized; what is the relative feasibility and cost of building vs. buying vs. outsourcing particular services; what is the timeframe of their availability; what fees are acceptable to charge or pay; what levels of service to offer or expect; etc.

Decisions about adopting B2B channel strategies must reflect the very fluid nature of the current business environment. Most B2B marketplaces have been in existence for several years at most, and are struggling to gain critical mass of participation and trade volume (liquidity). Some models, such as net markets and community models have fallen out of favor. Competition among the survivors is intense, particularly in commodity markets, as players consolidate, and jockey for market share. This intensive flux introduces significant strategic risk factors including opportunity costs (delay vs. join or build), and selecting the marketplaces most likely to survive the competitive environment. Costs to switch strategies or venues include lost revenues, market momentum and likely inferior positioning with respect to competitors.

Finally, the financial stakes for B2B channel decisions are high. Constructing a B2B marketplace is an expensive undertaking, easily costing $10 to $50 million. Establishing a market presence and brand, and integrating with member companies' information systems increases the investment range to $50 to $200 million. Ongoing staffing and operational costs can add $3 to $20 million annually.

Joining an existing marketplace incurs greatly reduced start-up costs, but ongoing outlays in the form of transaction or subscription fees; connectivity; and “learning curve” costs, both internal and for current trading partners. Internal computer systems must generally be re-engineering or replaced to permit secure exchange of information, supply chain visibility, and trading interactions with the external marketplace. Initial membership outlays can easily total several million dollars.

Many of the key decision factors relating to B2B marketplace options ground other kinds of strategic business decisions as well, albeit with different weights and interactions. For example, merger & acquisition decisions (M&A) depend on the overall market environment, current and projected economic conditions, the impact on the transaction on market share, partners, and cost structures, compatibility of information systems of the relevant parties, etc. Additional critical factors not present in B2B marketplace decisions include overall pricing and financing of the transaction, executive and employee support, shareholder support and rights plans, governance changes for the resulting business entities, regulatory implications, human resource issues such as executive retention and staff consolidation, and financial issues such as outstanding debts and credits, pension plan and tax consequences. Because of these commonalities, a suitable extensible system and method for supporting B2B marketplace decisions can be adapted to M&A and other strategic decisions, such as expanding or closing business units or production capacity.

### SUMMARY OF THE INVENTION

The present invention provides a set of modeling and analysis tools to help companies make informed strategic decisions in complex, rapidly changing market environments. The invention simulates the outcomes of candidate decisions over time, under different evolutionary scenarios that reflect assumptions about trends in a market and the overall economy, and the likely behavior of individual businesses. The invention then generates detailed analyses, both qualitative and quantitative, of the different outcomes, helping users to identify the decision option with the most attractive rewards and tolerable risks. The present invention also enables users to revisit prior decisions, by periodically updating models with current market data and refining behavioral assumptions based on observations. Users can then re-run the simulations and analyses to determine if decisions remain valid and optimal, or whether circumstances have changed sufficiently to warrant modifying initial strategies. The invention may have key applications in supporting strategic decision-making pertaining to business issues such as B2B channel strategies, mergers & acquisitions, creating (or dropping) products, business units, or production capacity, and to strategic decision making in military, legislative, healthcare, environmental, political, and other non-business domains.

An integrated set of dedicated strategy modeling and analysis tools in one embodiment of the invention may include capabilities to: (1) model current macro-economic conditions; (2) model characteristics of particular vertical or horizontal markets and the businesses that operate within them; (3) model online B2B marketplaces, either operating or proposed within those industrial contexts; (4) specify “what-if” scenarios that extrapolate current conditions and trends in the economy and markets and permit the injection of singular events such as wars, recessions, bankruptcies, etc.; (5) load the models and scenarios into an application engine that dynamically simulates the behavior of the market, B2B marketplaces, and participating businesses over a desired interval of simulated time (typically months to a few years); (6) monitor simulated utilization of B2B marketplace services by members, including simulated trade transactions, and simulated decisions regarding future participation in B2B marketplaces by all businesses within the given markets; (7) extract and save text-based traces of all simulated behaviors in a standardized file format; (8) import these log traces into a commercial spreadsheet package, and apply predefined macros and standardized reports to support users to sort, filter, condense, graph, and analyze outcome data to guide decision-making. For example, users can analyze the attractiveness of B2B marketplaces to new members, and study liquidity growth to help assess their relative likelihood of survival and profitability, which in turn helps users to select the most promising build, buy, join, or hybrid strategy.

In one embodiment, the present invention models the user's strategic decision context or domain in terms of a set of entities—economies, markets, businesses and business units, trade items, and B2B marketplaces. Entities have various characteristics or attributes, while populations of entities have aggregated statistical (demographic) characteristics. For example, a market has an overall size (in dollars of trade), an average transaction size, a set of products and services that are bought and sold, and comprises populations of businesses with estimated distributions of supply and demand market shares. Products and services, or trade items, have their own set of descriptive characteristics, such as price, perishability, degree of commoditization, etc.

One embodiment of the present invention models business trade channels, and in particular, B2B marketplaces, in terms of their service offerings. Examples of service offerings include content (e.g., on-line catalogs), commerce (e.g., sourcing, trading, fulfillment), collaboration (e.g., sharing of supply chain information), community (e.g., on-line discussion groups) and customer service. B2B marketplaces also have business models that specify membership rules, cost and revenue models, and rosters of businesses that have committed to join them and utilize their services.

The present invention models the businesses that participate in markets in terms of characteristics such as market share and annual purchase and sales transactions. Companies may encompass distinct business units, which operate more or less independently in different markets. Businesses in the model decision context may be specified statistically, in terms of aggregate populations and distributions of attributes; individually, based on available data about specific companies; or as a combination of statistical populations and “named” businesses.

The present invention allows businesses to adopt different roles with respect to trade items in different marketplaces. Buyers only purchase a given product within a certain market; sellers only supply the item; traders both purchase and sell goods. Traders include intermediaries such as brokers and distributors.

One embodiment of the present invention represents companies' interests in or need for B2B marketplace service offerings (vs. their current means for carrying out business processes). This embodiment also assigns businesses behavioral rules, which determine how companies decide to modify their participation in B2B marketplaces over time. These rules dictate how businesses adjust their utilization of services in marketplaces to which they currently belong (based on past performance and other factors) and how non-members decide whether or not to join available marketplaces.

The present invention enables the specification of scenarios to guide systematic analysis of decision options. The present invention adapts and extends the prior art method of scenario-based planning (SBP). See, e.g., Peter Schwartz, The Art of the Long View: Planning for the Future in an Uncertain World, Doubleday Currency, New York, 1991; Kees van def Heijden, Scenarios: The Art of Strategic Conversation, John Wiley & Sons, New York, 1996. SBP is a process developed and employed large organizations such as oil companies and the military, to deal with long-range strategic planning in situations involving high levels of uncertainty regarding their future operating environments. Scenario planning does not attempt to predict the future. Rather, it may enable organizations to: (1) formulate a spectrum of issues, trends, and factors that may impact them in the future; (2) envisage or project what the world would be like if specific conditions obtain; (3) assess these potential futures qualitatively; and (4) fashion strategies to respond effectively to a set of possible futures, thereby increasing the likelihood of success regardless of the future that actually transpires.

The present invention scales back the time horizon traditionally used in scenario planning applications, from ten to twenty years, down to six to twenty-four months, a time scale more suited to most strategic business decisions, particularly in the B2B marketplace domain. The present invention also extends the SBP process by coupling the method for defining scenarios to guide the assessment of decision options with a simulation engine, which projects concrete outcomes, modeled in extensive quantitative detail, of candidate decision options under alternative scenarios.

Given a decision context, comprising model entities—the economy, one or more markets, populations of businesses, and B2B marketplaces—scenarios depict assumptions about initial states of the economy, markets, and B2B marketplaces, and about trends that will drive future evolution. Examples include assumed allocations of supply and demand liquidity from members committed to particular marketplaces, together with assumptions about rates of failure for marketplaces to deliver the promised services (e.g., members failing to find trading partners for desired goods). Examples of environmental trends include macro-economic factors such as the annual rates of inflation and productivity growth, and market factors such as rates of growth and consolidation. Scenarios may also include singular events, such as wars, recessions, natural disasters, or major company events, that may occur and disrupt the anticipated evolution of the economic environment.

One embodiment of the present invention is tailored to help companies make considered decisions concerning their strategic options to participate in B2B marketplaces. The modeling framework grounds a standardized domain-specific methodology that enables users to gather, organize and maintain market data around a pre-defined set of decision factors. The framework also provides a standardized basis for formulating, organizing, and systematically exploring specific strategic decision options available in the B2B channel domain, including: (1) whether a business should build a private marketplace or B2B EMarketplace, either alone or as part of a consortium; (2) whether a business should join (i.e., participate) in private marketplaces or B2B EMarketplaces, and if so, which ones; (3) how the likely winners and losers may be identified so that the business may minimize risk and leverage scarce investment dollars; (4) whether an investor should underwrite the construction of such marketplaces; (5) whether an existing marketplace should owner partner with or acquire another marketplace; (6) whether an existing marketplace should invest in major functional enhancements; (7) how an existing marketplace might assess its positioning and value against competitors; and (8) how previous strategic decisions might be revisited and adjusted based on recent market developments.

The present invention incorporates a simulation engine that is driven by the decision context models and scenarios defined by users. This application engine is a novel parallel discrete event simulator that exploits a combination of statistical programming, causal mechanisms as embodied in system dynamics, and complex adaptive systems techniques—distributed agents and intelligent rule-based programming. See, e.g., Averill Law and W. David Kelton, Simulation Modeling and Analysis, 3^{rd} Edition, McGraw-Hill, 2000; George Richardson, Alexander Pugh, Introduction to System Dynamics Modeling with DYNAMO, Productivity Press, 1981; George Fishman, Monte Carlo: Concepts, Algorithms, and Applications, Springer, 1995. The synthesis of simulation techniques may be implemented using state of practice object-oriented languages and component-based frameworks.

In recent decades, researchers have studied economic markets and complex social organizations in an emerging discipline called complex adaptive systems (CAS). See, e.g., John Holland, Hidden Order: How Adaptation Builds Complexity, Perseus Books, Reading, Mass. 1995; Robert Axelrod, The Complexity of Cooperation: Agent-Based Models of Competition and Collaboration, Princeton University Press, Princeton, N.J., 1997; Joshua Epstein and Robert Axtell, Growing Artificial Societies: Social Science From the Bottom Up, 1996. Examples of CAS other than economies include biological systems such as natural ecologies, the immune and central nervous systems. CAS theories take a “bottom-up” to modeling complex systems. Conventional economic and operations research models employ top-down methods: describing systems in the aggregate via sets of differential equations or numerical methods. In contrast, CAS models explicitly depict the constituents of complex systems (e.g., businesses making up a market) as individual entities or agents, which have individual behaviors and rules for interacting with one another and with the environment. Aggregate system-level behavior emerges from detailed micro-level rule-based behaviors of distributed agents and their interactions with other agents and their environment. The present invention's application engine exploits CAS technologies, combined in novel ways with statistical simulation methods and simulated events to model the complex behaviors of economic markets and the businesses that participate in them.

The simulation engine directly manipulates the composite object-oriented model comprising the decision domain model, a decision option, and a scenario. In one embodiment of the present invention, the simulation engine manipulates the initial condition assumptions to generate the specified statistical population of businesses. It also assigns and normalizes market shares, marketplace memberships, and service utilization commitments.

The engine in this embodiment then simulates the activities and interactions of businesses and B2B marketplaces in their market environment, reflecting diverse sources of change over time. For example, the engine simulates fulfillment of company commitments to utilize 2B marketplace services, projecting sourcing actions and trades over time. At periodic intervals, the engine applies the behavioral decision rules associated with the model companies, resulting in changes in their marketplace participation based on their performance and other environmental factors. At other intervals, the engine applies rules that change the economic environment itself, based on assumed trends such as market growth, etc., and market populations, based on the assumed rate of business consolidation, etc. Simulated behaviors reflect both causal relationships between business entities (e.g., principles of economic theory relating price to supply and demand) and intentionality (e.g. goal-driven actions by intelligent agents), as appropriate. Finally, the engine injects singular events at their assigned times, further influencing businesses and their economic environment. The simulation engine provides graphical displays and controls to pause and resume the simulation, enabling users to monitor the progress of the simulation run.

The present invention logs all simulated model activities to a text-based trace that can be saved to a standard ASCII file, for post-simulation analysis and comparison to other simulation runs. Logged data is self-descriptive: each entry lists the names, in order, of all data elements in that record, facilitating analysis and automated report generation.

The present invention incorporates a data transfer facility that enables users to import simulation trace files into third-party data analysis tools, such as commercial spreadsheet packages, e.g., Microsoft™ Excel. The current embodiment of the present invention further provides a set of analysis utilities that generate reports and graphs that filter and reduce the simulator output, enabling users to focus on different aspects of individual marketplace and business performance, individual and aggregate business decision behaviors, and different kinds of environmental change. The spreadsheet format of the present invention includes a summary of all simulator inputs for a given run, to facilitate comparisons across runs and scenarios. All data is captured in columnar format, with descriptive headers, permitting users to further analyze data using the spreadsheet's native data analysis capabilities.

The present invention provides facilities to create, edit, and store decision contexts and scenarios persistently to a database. This allows models and scenarios to be retrieved and updated and refined for recurring use, allowing prior decisions to be revisited in light of current market data and learning from experience. The accuracy and credibility of simulated outcomes and analysis increases in a correspondingly incremental manner.

The present invention enables users to explore numerous scenarios selectively and adaptively, using quick-to-assemble coarse models and data to prune candidate strategies, and then adding more detailed behaviors and assumptions to examine the survivors more exhaustively.

By coupling SBP with rich simulation, the present invention enables users to understand decision outcomes more broadly than was possible previously, encompassing much more than quantitative financial factors. The present invention enables users to identify both adverse and positive consequences of decision options, and to better assess, trade off, and manage these risks and rewards, taken collectively.

The present invention's modeling and simulation frameworks are highly modular and adaptive, allowing entities, their attributes, and simulated behaviors and decision rules to be modified quickly and selectively. Thus, both models and simulations can be customized to fit decision-making in particular industries (e.g., factors and behaviors specific to chemical vs. steel markets). More radical changes allow the current embodiment of the invention to be applied to entirely different decision domains. For example, the constructs used to model B2B marketplaces and related behaviors can be removed, while models of regulatory bodies and business executives and their corresponding behaviors can be added, enabling the invention to help companies assess merger & acquisition decisions.

### BRIEF DESCRIPTION OF THE DRAWINGS

FIG. 1 depicts an exemplary scenario planning and simulation process, in one embodiment of the invention, which is used when making an initial (e.g., entry-level) decision;

FIG. 1A is a top-level view of an exemplary modeling framework, illustrating its key elements and groupings used by one embodiment of the invention;

FIG. 2 depicts an exemplary ongoing (rolling-forward) scenario planning and simulation process, in one embodiment of the invention, which is followed when users revisit prior decisions periodically to reassess them in light of present conditions;

FIG. 3 is a design diagram illustrating an exemplary architecture and operational roles in one embodiment of the invention;

FIG. 3A is a flow diagram illustrating the sequence of activities performed by users via relevant system components in order to carry out the core modeling and analysis decision support functions provided by one embodiment of the invention;

FIG. 4 is a view of the modeling framework, illustrating the high-level object-oriented model used to represent the key object models from FIG. 1A and their interrelationships in one embodiment of the invention;

FIG. 5 is a flow diagram illustrating an exemplary arrangement of model entities when engaged in simulated trading in one embodiment of the invention;

FIG. 5A is a flow diagram illustrating how simulated businesses utilize sourcing, trading, and other marketplace services separately or sequentially, in one embodiment of the invention;

FIG. 6 is a flow diagram illustrating exemplary top-level control flow for the parallel discrete event simulation engine in one embodiment of the invention;

FIG. 7 is a flow diagram illustrating the invocation of trading and sourcing services by EMarketplaces on their member businesses, in one embodiment of the invention;

FIG. 8 is a flow diagram illustrating an exemplary trading model (for fixed price trading, typical of catalog-based procurements), in one embodiment of the invention;

FIG. 9 is a flow diagram illustrating an exemplary approach to applying behavioral decision rules that drive business's simulated participation in EMarketplaces, in one embodiment of the invention;

FIGS. 9A and 9B are diagrams that illustrate the detailed structure of behavioral rules for businesses that determine how they update their participation in EMarketplaces over time, in one embodiment of the invention;

FIG. 10 is a flow diagram illustrating an exemplary algorithm for updating the market to reflect economic environmental trends in one embodiment of the invention;

FIG. 11 is an exemplary overall timeline that illustrates how the simulation engine applies behaviors and rules in one embodiment of the invention;

FIG. 12 is a screen display of an exemplary display window showing controls, parameter switches, and behavioral monitors in one embodiment of the invention;

FIG. 13 is a screen display of an exemplary trace window illustrating the simulation engine's execution log in one embodiment of the invention;

FIG. 14 is a screen display of an exemplary plot window illustrating trade metrics for a single EMarketplace in one embodiment of the invention;

FIG. 15 is a screen display of an exemplary plot window illustrating metrics for multiple EMarketplaces, in one embodiment of the invention; and

FIG. 16 is a screen display illustrating an exemplary report that summarizes the results of Update Market behavior during one simulation run, in one embodiment of the invention.

### DETAILED DESCRIPTION OF PREFERRED EMBODIMENTS

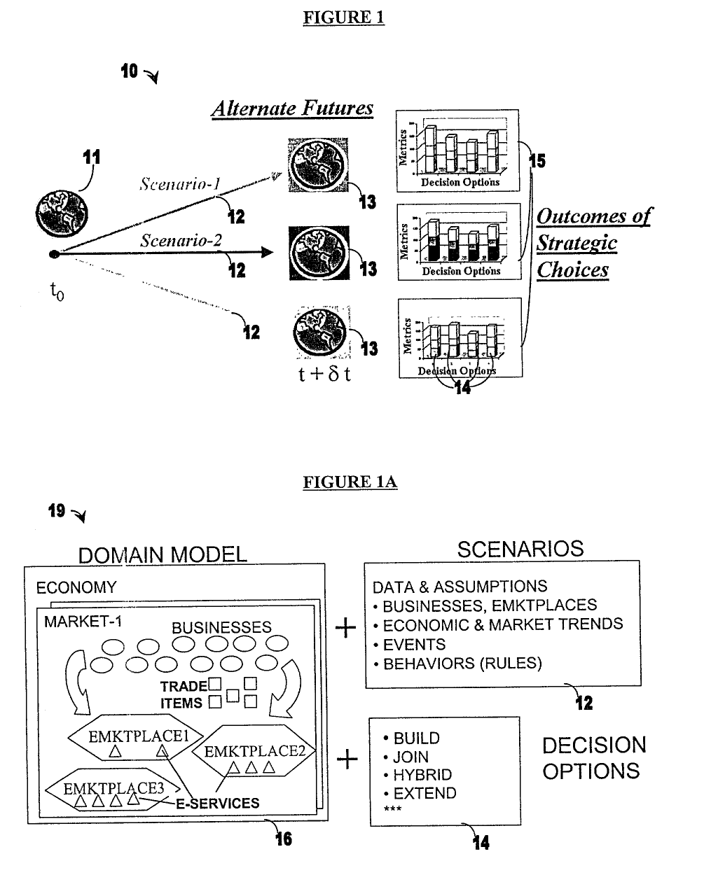

The present invention supports systematic decision-making by synthesizing the conceptual strategic modeling technique of scenario-based planning (SBP) with concrete simulations of the scenario-based models. FIG. 1 depicts an exemplary process 10 in one embodiment of the invention that illustrates how the two methods are combined. The SBP process is initiated by specifying the initial state of the world at an initial time tₒ 11. Specifying the state of the world consists of defining the decision context or domain model for the strategic decision, as illustrated in FIG. 1A, a top-level view of an exemplary modeling framework 19, illustrating its key elements and groupings used by one embodiment of the invention: the domain model 16, a plurality of decision options 14, and a plurality of scenarios 12. The domain model 16 identifies three kinds of elements: (1) the players that represent active agents in the decision domain, e.g., businesses and B2B marketplaces; (2) passive constructs that represent relevant, but non-autonomous objects in the decision domain, e.g., marketplace service offerings, products and services to be traded by businesses; and (3) environmental elements that characterize the underlying economic context or backdrop in which the players germane to the strategic decision interact, e.g., the economy, one or more markets. Active players have associated behaviors that enable them to modify their own state, behavior, and relationships with other domain model elements.

The second step of the SBP is to define scenarios 12, which specify known data and assumptions pertaining to the decision domain elements—players, passive and environmental objects. Assumptions depict estimates or other inferred information about decision model elements. Assumptions can either specify information about the initial time or they can represent trends, i.e., extrapolations of current conditions into the future. Examples of scenario data and assumed trends include: the current market shares for businesses for particular trade items in a given market; the projected subscription rates for the charter members of a new B2B marketplace; the annual rate of inflation; and the annual rate of growth of trades within a market. Scenarios may also specify events, such as a hypothetical shortage of raw materials at some future time tₓ, which may impact the economy, a market, its participating businesses, or some combination of these entities. Finally, scenarios specify the behavioral rules for domain model players (active agents), which will be described later in more detail.

The final step for the SBP is to specify the set of decision options to be assessed 14. Each decision option characterizes a possible strategy that the target business might pursue. In the B2B marketplace setting, a business might define several courses of action: build their own B2B marketplace, join an existing marketplace-1, join some other marketplace-2, or both build a marketplace and join EMktplace1. Each such option is reflected by variations in the domain model specification, the scenario specification, or in both. The simulation engine is then executed to project the states of world 13 at a future time t+δt from the domain models, scenarios, and decision options. The simulator produces a record or trace for each projection of a domain model, scenario, and decision combination, from which various summary reports are generated. The outcomes of the alternative decisions in the different possible futures are then assessed in terms of a set of computed performance metrics presented in these reports 15. In the present context, exemplary aggregate metrics may include total transactions executed in a given B2B marketplace, total dollar value of those transactions, and levels of trust by businesses belonging to particular B2B marketplaces. Metrics may also be maintained for individual businesses, recording individual trade transactions, utilization of other B2B marketplace services, and decisions to modify participation in the on-line marketplaces. Users assess and compare the pre-defined reports summarizing outcomes to identify the decision candidate that best fits their risk and reward objectives under the broadest possible set of scenarios. Based on initial studies, users may elect to perform additional analyses, modifying the domain models, scenarios, and decision options and running further simulation projections and analyses as necessary to refine their understanding of their options. This process is well suited for supporting initial or entry-level decisions.

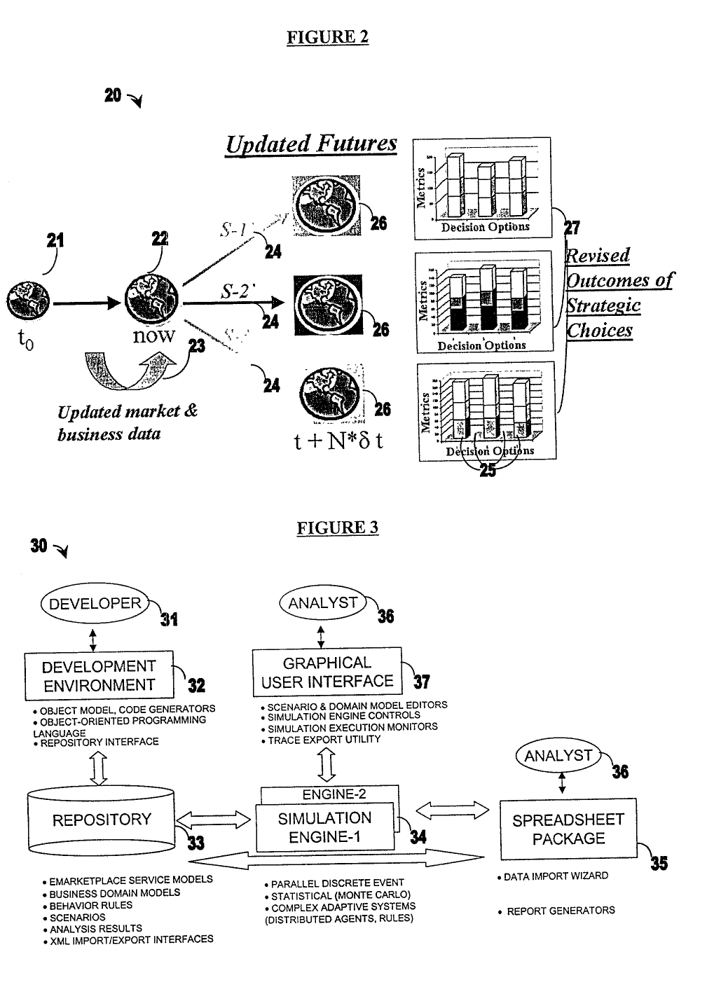

FIG. 2 depicts an exemplary ongoing (rolling-forward) scenario planning process 20 in one embodiment of the invention. Scenario planning may be most effective when it is carried forward iteratively over time, rather than being applied once, at a single instant. This may require establishing feedback loops, in which data is collected as the business environment continues to evolve, and fed back into the scenario planning process on an ongoing-basis to: (1) update the spectrum of possible conditions and choices; (2) refine domain model or scenario elements with new data; (3) validate assumptions and identify the subset of scenarios that appear to be coming true; (4) validate earlier strategic choices by assessing progress against current conditions, business goals and objectives; and (5) modify assumptions and strategic options as required and revisit the projections and analysis to adapt and refine them to ensure optimal outcomes. In the exemplary process 20, the process may begin at time tₒ 21, when the original decision is made (using the process described in FIG. 1). As time passes, actions to carry out the selected strategy are undertaken, and the economy, markets, B2B marketplaces, and businesses evolve to a new state 22. New market data, performance metrics, and observations of business behavior are collected at this point and used to update the decision context model 23. In addition, the original scenarios may be updated or replaced to reflect knowledge gained from experience (e.g., an original scenario now seems very unlikely, while a new scenario suggests itself) 24. The original decision options 25 may also need to be updated. For example, a build decision at time tₒ evolves into an operate-and-extend decision. Based on the updated model 22, scenarios 24, and decision options 25, new simulations are run to time t+N*δt 26. Updated metrics are computed, reported 27 and re-assessed by the user. In the content of assessing B2B marketplace options, three basic categories of data may need to be collected, aggregated or mapped, and fed back into the strategic planning process 22: (1) measurements of the results of company initiatives already put in place; (2) market conditions and trends specific to the industry or industries of interest; and (3) the latest refinements (or radical changes) brought about in the competitive landscape as B2B marketplace models continually evolve. Analogous factors can be updated in models for other kinds of strategic decisions, reflecting progress, market evolution, and market response to the projected decision. Feedback allows the SBP elements to be turned and refined incrementally, increasing user confidence in the projected futures based on confirmation and calibration.

### Market Models

The present invention models industrial markets in terms of a set of demographic, statistical, and qualitative characteristics, including numbers of businesses, broken down into buyer, seller, and trader categories, estimated distributions of market shares, market size, growth rate, and the nature of products and services being traded.

### General System Overview and Architecture

The present invention synthesizes a combination of modeling, simulation, storage, and analysis technologies expressly tailored to support strategic decision-making. These technology elements may be implemented and integrated using a component-based software architecture, to ensure modularity, maintainability, flexibility, and extensibility. See, e.g., R Johnson, “Frameworks=(Components+Patterns),” Communications of the ACM, October 1997, pp. 39-42; R. Adler, “The Emergence of Distributed Component Platforms”, IEEE Computer, March 1998, 43-53. Component architectures, properly designed and implemented, provide highly adaptable framework platforms for assembling, customizing, and integrating modeling and analysis components capable of addressing wide variations within and across particular strategic decision domains.

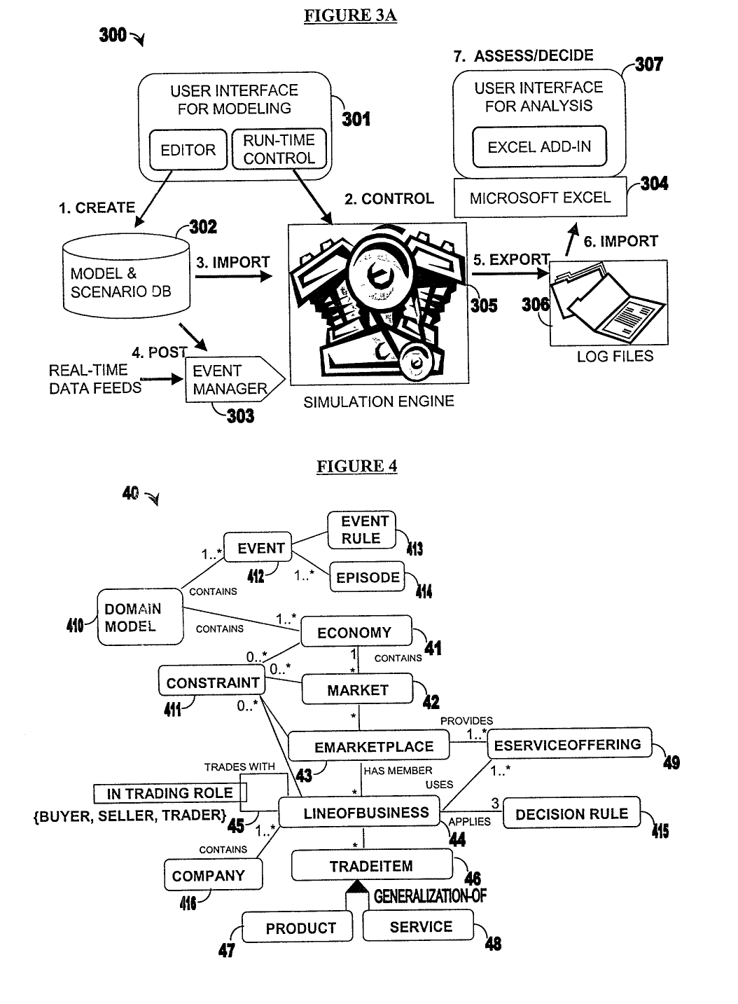

In one embodiment, three core sets of tools (development, modeling and simulation, and analysis tools) may be integrated to support an interrelated set of representation, execution, and analytic activities, all linked and supported by an underlying repository that provides persistent storage of work products. These tools may create the overall environment for the invention, encompassing primary operational uses—design-time, run-time, and post-run-time activities—and support, consisting of customization and maintenance. FIG. 3 illustrates an exemplary architecture and operational roles 30 in one embodiment of the invention.

The humans who interact with the system in this embodiment may comprise at least one developer 31 and at least one analyst 36. As shown, a developer 31 may use the development environment 32 to adapt or refine the core tools applied by the analyst in decision support—repository, graphical user interface (GUI) 37, modeling, simulation, analysis tools. The development environment may interface with the repository 33, which also interacts with the simulation engine(s) 34 and spreadsheet-based analysis tools 35. An analyst may access the invention via the GUI or the extended spreadsheet package to perform activities relating to strategic decision support—modeling the decision context, strategic options and scenarios, executing simulations to project outcomes of decisions, and analyzing these outcomes to select the most robust decision option. The components and functions of these architectural components are as follows.

### Development Tools

Development tools support the creation, maintenance, extension, and testing of the functionality of the present invention. One embodiment of the development environment for the invention 32 incorporates the following tools: (1) an object-oriented modeling environment; (2) an object-oriented programming language; and (3) an interface to a repository management system. The intended users of development tools are software programmers.

The object-oriented (OO) modeling environment is used to represent and maintain the conceptual framework that the invention uses to depict the elements of the decision context, scenarios, and strategic options 40. As noted earlier, the framework characterizes the information germane to decision-making in specific domains (e.g., B2B marketplace strategies, M&A due diligence) including the general economic and market environment, businesses, trade goods and services, events, and so forth. The modeling environment specifies the information in terms of a framework-based object model, which comprises object classes, member attributes and operations (procedural methods), associations, and interfaces. (See, e.g., Rumbaugh, Blaha et al.) The object-oriented (OO) modeling environment may support the Unified Modeling Language (UML), a widely accepted object-modeling standard. It may also generate baseline OO code to industry-standard languages, such as Java, Visual Basic, and Structured Query Language (SQL). SQL permits the generation of relational schema for persistent storage of model elements in a relational database management system (RDBMS) as well as commands to insert and update data for individual model elements into the database tables (and to delete them).

Object-oriented programming languages may be used to develop to implement the component tools in the invention, including the graphical user interface 37, the simulation engine 34, and the software that reduces the simulation outputs and generates reports 35. In addition, the object-oriented programming language (OOP) may also be needed to extend the object models for the strategic decision domains of interest. The object models capture non-procedural contents of the decision context, scenarios, etc. in declarative forms—viz., numbers, symbolic names, and text. However, some model elements require a specification of behavior that outruns purely declarative representations. In these situations, the OOP may be used to extend the declarative object model of the present invention with program modules called behavioral rules. Behavioral rules are code modules that capture programmatically simulated actions of domain players or interactions between domain players. Examples of behavioral rules include: (1) simulation of B2B marketplace processes for trading goods and services between businesses via fixed-price catalog sales or Request For Quotation (RFQ) models; (2) simulation of utilization of other value-added marketplace services by member businesses, such as sourcing or on-line payment; (3) decision rules that simulate how businesses change their participation in B2B marketplaces, e.g., increase trading, subscribe to new services, withdraw from a marketplace, join a new marketplace); (4) business rules that simulate how markets evolve (through aggregate growth or shrinkage, as well as from individual business transformations such as formation, closures, mergers and acquisitions); and (5) business rules that simulate how external events impact the simulated environment (economy and market) and the model's constituent players (e.g., natural disasters that result in shortages of materials and price increases; production stoppages, regulatory changes, mergers of specific businesses).

The repository management system 33 provides persistent storage services for the development environment and for the tools making up the present invention. In particular, the repository stores the declarative model elements, data, and relationships that depict contexts, scenarios, and decision options for particular decision domains. The repository also stores and provides version management services for the source and compiled code bases for the tool components of the present invention (GUI, simulation engines, analysis reports, custom import-export utilities) and for the procedural behavioral rules that extend specific decision domain models. The repository may use the industry-standard relational database model and expose access to its storage services via SQL, run-time Java Database Connectivity (JDBC) and eXtensible Markup Language (XML) Application Programming Interfaces (APIs). The tools within the present invention may use these APIs, along with custom code as required to translate or map between the native relational format of the repository and their own representations via specific objects, spreadsheet cells, etc. These interfaces are bi-directional, enabling import of data from external third-party data sources and export of data from the present invention to external users or data management systems. The tools may also employ other industry-standard data formats (e.g., ASCII comma-delimited format or CSV) for transferring data between the components of the present invention.

### Graphical User Interface

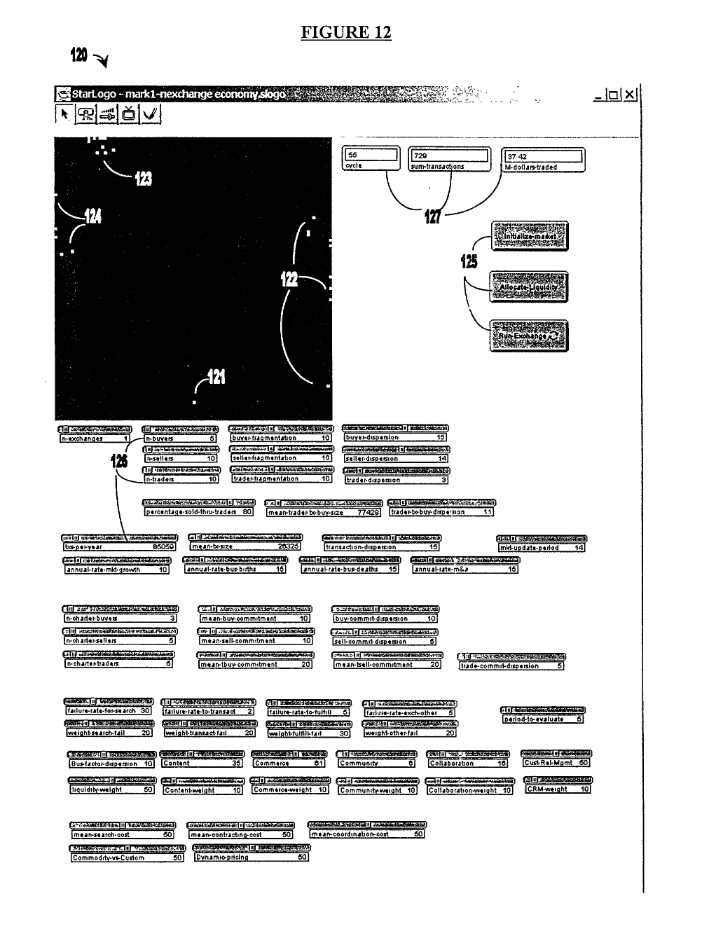

The graphical user interface (GUI), e.g., as represented in the exemplary screen view of FIG. 12, may enable analyst users of the present invention to control and monitor the system's core modeling and simulation tools.

In one embodiment of the invention, the GUI for the modeling subsystem contains a set of editor controls including sliders and text windows that enables users to specify the domain model, decision options, and (declarative) scenario elements. Alternate embodiments may provide inputs via spreadsheet-based templates, whose cell values are saved to a standard ASCII file format and then loaded via a model import facility. Yet another embodiment may provide unified editors based on hierarchical tree controls (where nodes allow specification of domain model objects such as scenarios, economies, markets, businesses, events) analogous to Windows and Unix file management system editor windows.

FIG. 12 is a screen display of an exemplary primary display window 120 in one embodiment of the invention. In one embodiment of the invention, the GUI for the simulation subsystem provides a set of button controls 125 for (1) initializing the simulation engine with the currently loaded domain model, decision option, and scenario; (2) for generating the statistical distributions and normalizations implemented through the Monte Carlo programming elements of the simulation engine; and (3) for starting, pausing, resuming, and halting the simulation run. A set of slider controls 126 allows the domain model, decision option, and scenario to be specified. Other slider controls enable the user to set switches that control the behavior of the simulation engine. For example, one control allows users to set periods or intervals, measured as integral numbers of simulation cycles, that control when certain agent behaviors are invoked (cf. Update-Players and Update-Markets below). These settings can be changed without modifying the decision models and scenarios themselves, as defined in the modeling GUI and stored in the repository. Additional controls enable the user to save the trace log to an external ASCII file in a format compatible with commercial spreadsheet import facilities.

In one embodiment of the invention, the GUI for the simulation subsystem also provides a set of controls and graphic windows for monitoring the progress of the simulation as it executes. A set of text window controls 127 may show simulated elapsed time and aggregated metrics such as cumulative trades and dollars traded across an industrial market. A separate graphical window may display the individual players within the decision domain, depicting business metrics that help the user gauge how the model is evolving. For example, one embodiment of such a monitor window shows B2B marketplaces 121, and businesses within a target market organized by their role in trading a particular good (buyers 124, sellers 122, and traders 123). Coordinates of these players along the vertical axis of the window corresponds to their market share for the trade good, where larger values indicate larger market shares, while the horizontal access indicates “trust,” a metric that reflects continuous membership and liquidity commitment to a B2B marketplace. Users can determine at a glance how many players continue to participate in marketplaces and with what levels of commitment.

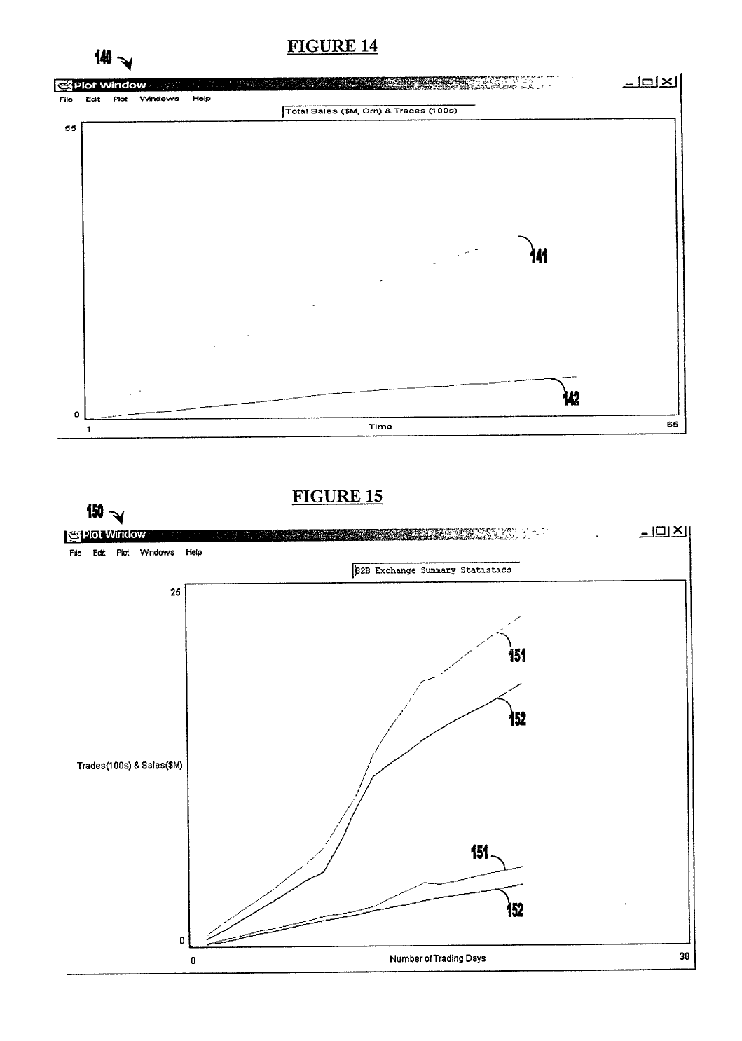

Another graphic display window may show cumulative aggregated metrics for the simulation model. FIG. 14 is a screen display of an exemplary plot window 140 in one embodiment of the invention. This window 140 may display cumulative sales in $M 141 and cumulative number of trade transactions in 100s 142, through a single EMarketplace, while the window in FIG. 15 summarizes comparable cumulative sales 151 and trade 152 statistics over time for an industrial Market in which two B2B EMarketplaces are competing with one another.

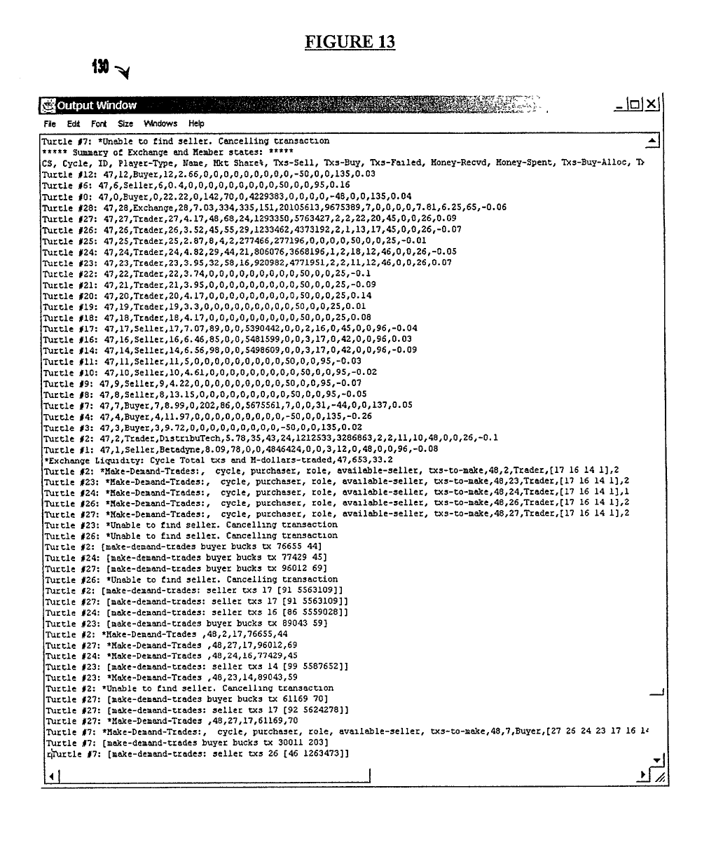

Finally, FIG. 13 is a screen display of another exemplary log/trace window 130 in one embodiment of the invention. This window 130 displays the quantitative data produced by the simulator as a trace log of the execution run. This data can be exported to a CSV file where it can loaded into a spreadsheet package, summarized, and reviewed to understand the outcomes of the alternative decision options and select between them for the best risk-reward profile. It should be understood that, although FIGS. 12-15 are illustrated herein in black and white, color displays may also be used for screen and/or printed output, to distinguish points, lines, buttons, and/or other features shown to a user.

### Simulation Tools

The simulation tools of the present invention provide the run-time specification, execution, and execution control facilities that support dynamic modeling of markets and marketplaces as complex adaptive systems. In one embodiment of the invention, the primary tool in this category is the simulation engine. The GUI-based control and monitoring facilities for this engine are described above.

The GUI is used to select the domain model, scenario, and decision option to be loaded into the system. In one embodiment, this selection facility then loads the relevant objects and behavioral rules (code modules) from the repository into memory, whereupon the other simulator GUI controls can be used to initiate, monitor, and suspend the simulation engine.

In one embodiment, execution engines may be used to apply a novel synthesis of complementary simulation techniques to explore the dynamics of particular strategic decision contexts. Simulation engines are application modules that may use different simulation technologies and may contain custom instrumentation to capture the execution trace and record it in a standardized log file format.

One embodiment of the invention features parallel discrete event techniques for simulating CAS, variously known as “artificial life” or agent-based modeling. In this approach, the simulation engine cyclically invokes behavioral rules associated with a population of model players (active agents). A rule is a code module that enables each agent to modify its state and possibly the state of its environment as a function of its state, the states of its peers and other environmental objects. Rules may simulate behaviors to the level of trade interactions between individual businesses or the provisioning of other services such as sourcing or on-line payment, the process undertaken by regulators and interested parties in assessing antitrust consequences of a transaction, and so on. CAS techniques enable fine-grained, micro-economic level simulations of economic markets and their response over an extended interval of time to perturbations resulting from a company's decision to build or join a B2B marketplace, participate in a merger or acquisition, etc. The CAS-based simulation approach may be useful for studying particular scenarios to understand so-called “emergent” behaviors, both qualitative and quantitative, in which the aggregate behavior of the economy and markets hinges on activities and interactions of the individual players within the domain model. The present invention's CAS-based simulation encompasses both causal (i.e., dynamic economic theories) and intentionality (i.e., autonomous, goal-driven adaptive behaviors on the part of individual model business entities).

The second exemplary aspect of the execution engine applies statistical simulation methods, known as (Markov chain) Monte Carlo programming. These techniques may be well-suited for coarser-grained simulations that reveal aggregate EMarketplace behavior and trending over time. In essence, Monte Carlo methods permit “mass production” of populations and execution of a spectrum of scenarios that vary slightly from one another. For example, one embodiment of the invention uses Monte Carlo techniques to generate statistical distributions of values over business populations, such as market share and interest in B2B marketplace service offerings. The collection of outputs from Monte Carlo simulations may be assessed to identify worst-case results, i.e., when scenario parameters exert combined maximum negative impact on the desired outcome, best-case results, and most likely (expected) outcomes. Embodiments of the invention's simulation engine may combine Monte Carlo and CAS techniques, wherein agent populations are exercised using CAS-based parallel discrete-event behavioral simulation, while the characteristics of the agents, their environment, and scenarios, and attributes that modulate or determine their behaviors are generated using Monte Carlo programming to introduce statistical variation.

The third exemplary simulation technique exploits another synthesis of statistics and artificial intelligence. This technique, called genetic algorithms, is patterned after the reproduction of the DNA in biological systems. A population of candidates, typically represented as coded strings is assembled and tested against a “fitness function”. Low scoring candidates are weaned and high scoring “survivors” are bred—i.e., pieces of their strings are modified (“mutated”) or interchanged with one another (“bred” or “reproduction”). Scoring and breeding are repeated over hundreds or more cycles. Genetic algorithms may be useful in determining optimal (in terms of Darwinian “natural selection-based survival of the fittest”) solutions to complex problems such as supply chain optimization. This technique would be used in decision-making applications to optimize a given strategic course of action once selected by other techniques from very different strategic alternatives. See, e.g., Holland; M. Mitchell, An Introduction to Genetic Algorithms, MIT Press, Cambridge, Mass., 1997.

### Analysis Tools

The analysis tools of the present invention provide the post-simulation capabilities to examine the results of running particular scenarios, both quantitatively and qualitatively. The resulting assessments may represent unique inputs to businesses for understanding the possible ramifications of strategic decision options such as mergers or marketplace participation choices. As noted before, analysis of simulations of the present invention may provide a systematic basis for making strategic decisions in a coherent, informed manner. Specific exemplary tools in this category may include (1) a commercial spreadsheet software package, such as Microsoft™ Excel, that imports the log files from model simulation runs, enabling users to sort and graph the data, compute metrics, and assess the scenario outcomes; (2) predefined macros to produce standardized reports; (3) sensitivity analysis software, which may analyze multiple simulation outputs and may be capable of identifying and prioritizing the independent variables (input assumptions) that exert the maximum influence on outputs (i.e., dependent variables such as EMarketplace liquidity and revenue); and (4) integration interfaces to the repository, for saving new analysis reports and log files and for retrieving old ones for purposes of comparison.

### Activity Flow

FIG. 3A illustrates an exemplary flow 300 of activities by analyst users of one embodiment of the present invention. Via the user interface 301, users first create the model of the decision to be made, comprising the domain model, decision options, and scenarios. These elements are stored in the repository 302. Using the GUI's simulation control interface, the analyst then selects the desired model, option, and scenario, which is loaded into the simulation engine 305 and executed. The event manager 303 may be used to inject events into the simulation engine 305. Results are extracted in a file-based form 306, which the analyst can import into a third-party and/or commercial spreadsheet 304 using the invention's spreadsheet add-on utility. The analyst then reviews the simulation data, via a user interface 307 that may include both predefined reports and native analytic tools of the spreadsheet 304, as required.

### Business Decision Modeling Framework

FIG. 4 is a top-level view of the modeling framework, illustrating the object model 40 used by one embodiment of the invention applied to the B2B marketplace decision domain. The model uses Unified Modeling Notation (UML), as those skilled in the art will recognize. The top-level object class is called the Decision Model, which aggregates all of the classes that comprise the domain model/decision context, scenarios, and decision options. As shown, the Decision Model ultimately contains the following primary classes: Economy 41, Market 42, EMarketplace 43, Event 412, LineOfBusiness 44, Company 416, and TradeItem 46. The model also allows Constraints 411 to be represented, which express logical restraints on attribute values and relationships. For example, a scenario may specify that a LineOfBusiness may not belong to more than two EMarketplaces. Another key constraint, involved in generating populations, is that the total market shares for LineOfBusiness entities within a given Market must not exceed 100%.

The lines in the diagram indicate associative relationships, which may have labels and cardinality assignments. Thus, the DecisionModel contains one or more Events 412 (1 . . . *), and a Market 42 has 0 or more (*) Emarketplaces 43. Primary objects in the model may have secondary or supporting objects. Primary classes may have associated secondary classes that extend the model with organizational and behavioral elements. For example, Events 412 can be organized into related groups called Episodes 414. Companies 416 may have multiple, independent divisions or units (LineOfBusiness 44) with distinct products, behaviors, and relationships with Markets 42 and Emarketplaces 43. TradeItems 46 include Products 47 and Services 48, which have different kinds of characteristics. A LineOfBusiness 44 may adopt different TradeRoles (Interfaces) with respect to different TradeItems 46 and Emarketplaces 43. Finally, primary objects may be associated with programmatic objects (behavioral rule classes), which specify their behaviors in simulations. A LineOfBusiness 44 has DecisionRules 415, Emarketplaces 43 have ServiceOfferings 49, such as Trading and Sourcing, and Events 412 have EventRules 413, which specify the impact of the events on the decision model within a simulation.

As those skilled in the art will recognize, object-oriented technology aims to organize information and code more effectively than standard procedural languages such as Fortran or C. Briefly, an object class such as a Market 42 may define a set of descriptors (called attributes or properties), and behaviors (implemented with modules of code called procedures or methods). An application creates instances of the class, which are the primary computational entities when the program executes. That is, an object class is primarily a design abstraction for defining and organizing program elements. All subclasses of Market 42 share (or “inherit”) these descriptors and behaviors. However, they may define additional descriptors or behaviors and modify or “override” class-level default property values and implementations of behaviors. This is the meaning of specialization. For example, “executives”, “managers”, and “line-employees” may all be subclasses of a superclass “employee”. “Executives” may have responsibility for business units, while “managers” manage individual line-employees, but all three types of “employees” share a common set of descriptors (e.g., name, job role, business unit, home address, years of service, benefits). In the present context 40, TradeItem 46 is a generalization (or superclass) of two common sub-categories called Products 47 and Services 48. p In the framework illustrated in FIG. 4, the root entity that provides the context for all simulation elements is called the Domain Model 410. There is one and only one (instance of) Domain Model 410 in the core framework. The Domain Model 410 may contain one or more Economy objects 41. The Economy class may serve several design roles in the modeling framework of the present invention. In the first design role, the Economy class may serve as an anchor to the model entities that are primary with respect to simulating the target business domain, namely Markets 42. In this capacity, the Economy 41 may provide an environment or context for defining multiple Markets 42. This may be important, because EMarketplaces 43, particularly for horizontal markets such as human resources and indirect procurement, often span multiple (vertical) industrial Markets. The Economy class 41 makes it possible to anchor multiple Markets 42 in a single Domain Model 410, so that EMarketplaces 43 may service businesses belonging to multiple Markets 42 simultaneously. In concrete terms, the anchoring may take two forms: (1) the Economy 41 may define parametric factors that hold across all Markets 42 (i.e., they may be “global” for Markets 42, as Market data may be “global” for all constituent EMarketplaces 43); and (2) the Economy 42 may provide a simple mechanism through the associative link contains for identifying (and/or retrieving) all Markets 42 defined in a particular model. In the second design role, the Economy 41 class may provide the modeling nexus for representing macroeconomic factors that represent environmental factors broader than individual Markets, including inflation, taxation, and wars. In the third design role, multiple Economy objects 41 may be introduced to partition environmental conditions (and Markets) according to domestic and global economies or comparable distinctions.

Markets 42 may represent aggregations of economic activity that correspond to particular industries such as steel, automotive products, and textiles, commonly called “vertical markets”. Markets 42 may also encompass aggregations of economic activity that span multiple vertical markets, including professional services, safety products and services, and office supplies, commonly called “horizontal markets”. An “aggregation of economic activity” simply refers to the constellation of producers and consumers of a related set of products and services. Markets 42 may contain zero or more B2B EMarketplaces 43.

A B2B EMarketplace 43 may refer to any Internet-enabled B2B commerce organization that brings together buyers and sellers of goods and services. In this sense, B2B EMarketplaces 43 may subsume the various business models discussed hereinabove: net markets, industry-sponsored consortia, outsourced trading services, community-based markets, trading networks (e-hubs) and private marketplaces. A more detailed representation of the object model may represent each of these variants as a specialization or subclass of B2B EMarketplace 43, which is called the parent or superclass to these subclasses. B2B EMarketplaces 43 may contain zero or more member LineOfBusiness classes 44.

It is noted that a B2B EMarketplace 43 may be associated with multiple Markets 42. This may invariably occur in the case of EMarketplaces 43 that target horizontal markets. However, EMarketplaces 43 for Markets 42 that deal with basic commodities, such as metals, chemicals, etc., may tend to intersect with other market categories that consume those goods, such as automobiles and construction. In short, Markets 42, vertical as well as horizontal, may be defined somewhat loosely. They may not be strictly disjoint (with mutually exclusive participants and goods); rather, they may overlap considerably. It is contemplated that the model of the present invention be adapted to reflect this broadness of categorization.

LinesOfBusiness 44 belong to one or more Markets 42, and may join B2B EMarketplaces 43 to buy and sell relevant Products 47 and Services 48. LinesOfBusiness 44 may trade with one another within the context of particular EMarketplaces 43 or directly with one another. The B2B marketplace embodiment of the present invention simulates only the trades that take place within EMarketplaces 43 in an explicit manner. It tracks the percentage of market trades that take place external to those contexts, but does not simulate such activities explicitly.

Joining an EMarketplace 43 may involve consenting to contractually binding terms that specify standard practices and expectations about how business will be conducted on the EMarketplace 43, the costs of using EMarketplace 43 ServiceOfferings 49, and so on. Again, the modeling framework reflects the non-exclusivity characteristic of the business world: LinesOfBusiness 44 are generally free to participate in multiple EMarketplaces 43, across different markets 42. Large corporations (Company 416 objects) with diverse business units, such as GE, DuPont, etc., may build or join numerous Emarketplaces 43. LinesOfBusiness 44 may buy and sell zero or more TradeItems 46 within a market 42 and within particular B2B EMarketplaces 43.

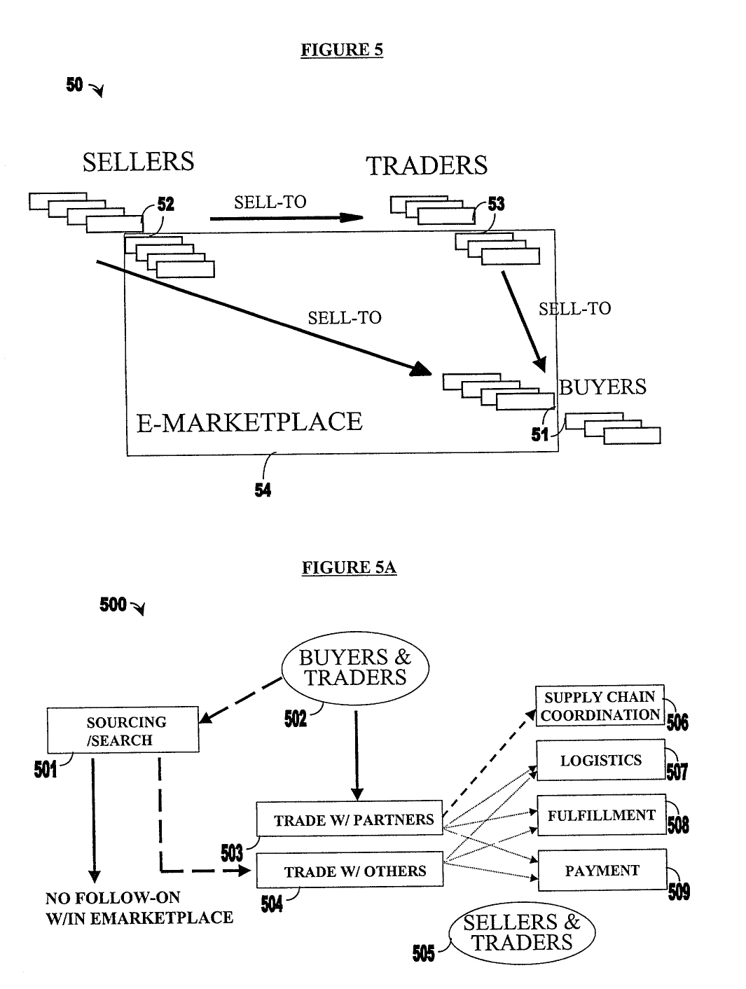

Embodiments of the invention may support three distinct types of trading behaviors, or TradingRoles 45 for LinesOfBusiness 44, as FIG. 5 further illustrates. As shown in FIG. 5, an exemplary arrangement 50 of model entities and trade relationships in one embodiment of the invention, the three roles may be: Buyers 51, Sellers 52, and Traders 53. Within a given B2B EMarketplace operating within a Market, a LineOfBusiness plays the TradingRole of Buyer if it is limited to purchasing the given TradeItem within that EMarketplace. Within a given B2B EMarketplace operating within a Market, a LineOfBusiness plays the TradingRole of Seller if it is limited to selling the given TradeItem within that EMarketplace. Finally, a LineOfBusiness plays the Trader role if they both buy and sell the given TradeItem within the EMarketplace. In the current embodiment, a LineOfBusiness may play different Trading Roles for the same TradeItem in different EMarketplaces, but always play the same Role within one and the same EMarketplace.

Trader behavior enables the modeling framework to support traditional middleman commerce functions carried out by intermediary businesses such as brokers, agents, and distributors. A B2B EMarketplace54 may be a LineOfBusiness 44 in its own right. In particular, an EMarketplace 54 may buy or sell goods within its own context. This practice may apply not only for businesses 44 that set up private marketplaces, but also for net markets or industry-sponsored consortia that choose to participate in, as well as support, transactions. In the latter role, the B2B EMarketplace 54 may essentially act as a Trader 53 operating within the EMarketplace 54. It is noted that this scenario may raise business model issues outside the scope of the invention, e.g., whether other LineOfBusiness members of that EMarketplace will trust that that firm will apply its trading rules fairly when it has a vested interest.

A LineOfBusiness 45 may trade with any other LineOfBusiness 45 in the context of a particular EMarketplace 44. However, LinesOfBusiness may often enter into preferred or dedicated relationships with one another, most notably through long-term contracts. Such contracts may commit LinesOfBusiness in complementary Buyer 51 and seller 52 TradingRoles to supplying and purchasing goods or services under specific pricing schedules over an extended period of time, which may serve to minimize risk by guaranteeing supply and demand. Such agreements may presuppose a process of mutual qualification (e.g., checking creditworthiness, manufacturing capacity and certifying product quality and specifications). Embodiments of the invention may represent this kind of relationship explicitly within the modeling framework, including quantitative reservations of supply and demand liquidity for particular TradeItems between trading partners.

LinesOfBusiness may be specified in the domain model in two ways—by-population and by-name. The by-population approach specifies the overall number of businesses within a Market and specifies statistical distributions of key LineOfBusiness attributes, such as market share and level of liquidity commitment to particular EMarketplaces. The by-population approach is useful for creating a domain model rapidly and for situations where market knowledge is limited to trade publications or government statistics. One embodiment of the invention stores LineOfBusiness “by-population” data in dedicated statistical objects called Generators, which are associated with the particular Markets in which context these business populations operate. In many cases, analysts using the present invention to make strategic decisions have more detailed information. For example, many industrial markets contain public companies that own significant supply or demand market share, such as the Big Three automotive companies, GE and United Technologies in the aircraft engine market, Wal-mart and Target in the retail industry, etc. Equally, a company that wants to model its own behavior certainly knows its own market characteristics. In these cases, analysts can define LinesOfBusiness “by-name”, creating specific LineOfBusiness objects with particular names and attribute values. Entry of “by-name” data can be laborious, but it reduces the variability and increases the fidelity of simulator outputs.

In the B2B EMarketplace embodiment of the present invention, EMarketplaces may offer multiple kinds of ServiceOfferings to their member LinesOfBusiness. FIG. 5A depicts current and potential service offerings and their relationships to one another 500. A LineOfBusiness, representing a company that is either a Buyer or a Trader in purchase mode, may need to locate desired Trade Items and suppliers in an EMarketplace. The corresponding ServiceOffering is known as Sourcing or Search 501 (as in catalog look-ups). A LineOfBusiness may perform a Sourcing 501 action without proceeding to carry out a trade (negotiated, reverse auction, catalog-based purchase). Sourcing, if successful, identifies a trading party, namely a Seller or a Trader in sales mode of the desired trade item 505. Alternatively, the LineOfBusiness may elect to interact with the LineofBusiness identified or selected through the Sourcing 501 activity to conduct a trade 504, as shown by the arrow linking the Sourcing 501 to the Trade with Others 504. A Buyer or Trader 502 LineOfBusiness may also elect to conduct a trade 503 with an existing trading partner 505. This represents a transaction that presupposes a Sourcing 501 action that took place some time in the past and need not be repeated within this EMarketplace. A trade 503 represents an agreement to EMarketplace money in return for the desired TradeItem. EMarketplaces may provide ServiceOfferings that enable LinesofBusiness to carry out post-trade activities 506-509 within the on-line, Internet-based e-commerce environment rather than through conventional phone, paper-based mail channels. FIG. 5A illustrates the flow between trades 503, 504 and simulated post-trade activities such as Fulfillment 508 (completing documentation, picking and preparing goods for shipment, problem resolution) Logistics 507 (arranging and managing delivery of physical goods), Payment 509, and Supply Chain Coordination 506 (sharing of inventory and stock information between trading partners). These ServiceOfferings, and the logic required to flow between these activities represent straightforward embodiments of the present invention. In Sourcing and Trading, players 502 play the active role—seeking out and initiating trade with the players in Seller roles 505. In some services, such as fulfillment 508, Sellers and Traders in selling roles 505 may play active roles, and in other services, supply chain coordination and logistics, the trading parties 502 and 505 may interact collaboratively as full service peers.

Events provide the capability to inject singular occurrences as well as assumed or predicted trends into the scenario (see reference numeral 114 of FIG. 11). Events can be pre-defined as static model objects or imported in real-time from an external data feed. (In both cases, an event manager injects them into the simulation engine.) Events enable decision-makers to study the impact of external occurrences, such as materials shortages, disruptive political events or natural disasters, or simulated business events, such as a possible merger between two large industry players on their strategic decision options. This allows assessment of the robustness of a decision in the face of singular events, and in some cases, simulation of strategic actions that might mitigate the anticipated negative economic effects of such events (such as currency hedging, materials stockpiling, or other kinds of disaster recovery/contingency planning).

Equally, other embodiments of the present invention applied to other kinds of strategic decisions introduce different entities (e.g., Regulators, Managers) roles (acquirer), and behaviors (apply for approval, grant approval, consolidate operations) to develop Decision Models in those other business domains.

Tables 1 through 5, below, further detail exemplary specifications of the domain modeling framework in one B2B EMarketplace embodiment of the invention. These specifications, represented in tabular format, capture the detailed declarative structure of the object classes comprising the domain model. This structure consists of member attributes for the primary classes depicted in FIG. 4. Table 1 enumerates and describes exemplary member attributes for the Economy 42 class. Table 2 enumerates and describes exemplary member attributes for the Market 43 class. Table 3 enumerates and describes exemplary member attributes for the EMarketplace 44 class. Table 4 enumerates and describes exemplary member attributes for the LineOfBusiness class 45. Table 5 enumerates and describes exemplary member attributes for the TradeItem Product subclass 47 (to which exemplary attributes of the TradeItem Service class 48 may be similar).

TABLE 1
Exemplary Attributes for Economy

| Attribute | Description |
|---|---|
| Name | may be used to track Economy instance by |
| | symbolic identifier (allows future extension to |
| | support multiple Economies, for example |
| | Global and Domestic, within the World) |
| Annual-Rate-of-Inflation | may be used for parameters representing |
| Annual-Rate- | macroeconomic environmental conditions. |
| Productivity-Change | Other parameters reflecting cost factors such as |
| | taxation rates may also be added |

TABLE 2
Exemplary Attributes for Markets

| Attribute | Description |
|---|---|
| Name | may be used to track Market instance by |
| | symbolic identifier |
| N-Buyers | may accumulate user-supplied statistical |
| N-Sellers | estimates of total number of Buyers, |
| N-Traders | Sellers, Traders within the given market |
| N-EMarketplaces | may track number of B2B EMarketplaces |
| | (operating or proposed) for Market |
| Buyer-Fragmentation | may represent user-supplied estimate of |
| Seller-Fragmentation | the relative degree (percentage) of |
| Trader-Fragmentation | fragmentation within an industry of |
| | Buyers, Sellers, Traders. May be used to |
| | compute Market-Shares |
| Buyer-Dispersion | may represent user-supplied estimate of |
| Seller-Dispersion | one Standard deviation around the mean |
| Trader-Dispersion | size (in percentage) within an industry of |
| | Buyers, Sellers, Traders. May be used to |
| | compute Market-Shares |
| Buyer-Normalization | may represent accumulator for total |
| Seller-Normalization | sampled market share; may be used to |
| Trader-Normalization | normalize values |
| Percentage-Sold-Via- | may represent user-supplied estimate of |
| Traders | the relative percentage of Trade Items |
| | traded indirectly, via intermediaries such |
| | as Brokers and Distributors |
| Nmbr-Buyers | may accumulate total number of Buyers/ |
| Nmbr-Sellers | Sellers/Traders, both statistically generated |
| Nmbr-Traders | (N-Buyers) and from Imported Data |
| N-Charter-Buyers [] | may track number of Buyers/Sellers/ |
| N-Charter-Sellers [] | Traders created from statistically |
| N-Charter-Traders [] | generated data for initial membership in |
| | EMarketplaces |
| N-Import-Buyers | may accumulate number of Buyers/Sellers/ |
| N-Import-Sellers | Traders created from Imported Data |
| N-Import-Traders | |
| Atomic-Time-Unit | may represent the unit interval over which |
| | simulator runs trading; may be used as a |
| | divisor, so 1 = 1 year per cycle, 365 = 1 |
| | day per cycle, 8760 = 1 hour (365 * 24), |
| | etc. |
| Transactions-Per-Year | may represent size of the Market in |
| | volume of trades conducted per year |
| Market-Transactions-Per- | may hold adjusted txs-per-year (reflecting |
| Year | industry growth rate) |
| Transaction-Flow | may represent average number of trans- |
| | actions in a Market per atomic unit of time |
| | (i.e., Transaction-per-Year/ |
| | Atomic-Time-Unit) |
| Mean-Transaction-Size | may be user-supplied estimate of mean |
| Mean-Trader-Transaction- | value of transactions (in US dollars). One |
| Buy-Size | attribute may cover Buyers and Sellers and |
| | Traders in Sell mode; the other may reflect |
| | that Traders may buy larger quantities |
| | (e.g., distributors). |
| Transaction-Dispersion | may represent the user-supplied value for |
| Trader-Transaction-Buy- | one standard deviation in the distribution |
| Dispersion | for transaction sizes. One attribute may |
| | apply to Buyers and Sellers and Traders in |
| | Sell mode; the other may reflect that |
| | Traders may buy larger quantities (e.g., |
| | distributors). |
| Traders-Trade-With- | may indicate whether Traders buy and sell |
| Themselves? | amongst themselves or strictly with pure |
| | sellers and pure buyers |
| Market-Update-Period | may be user-supplied value of number of |
| | cycles (atomic time units) after which |
| | Update-Market is called to adjust |
| | aggregate Market population due to pro- |
| | rated effects of annual rate of change |
| | factors |
| Annual-Rate-Market-Growth | may represent annual percentage rates of |
| Annual-Rate-Bus-Births | change in the Market due to growth |
| Annual-Rate-Bus-Deaths | (shrinkage) in number of transactions, new |
| Annual-Rate-M&A | business formation, business closures, and |
| | business consolidation |
| Mean-Search-Cost | may represent user-supplied estimates of |
| Mean-Contracting-Cost | industry-wide costs for overhead |
| Mean-Coordination-Cost | contributions to overall transaction value, |
| | relating to trading parties finding suitable |
| | counter parties and Trade Items and |
| | establishing price; trading parties carrying |
| | out the transaction; and trading parties |
| | completing subsequent business processes |
| | relating to delivering and paying for |
| | the goods (may be adapted from Ronald |
| | Coase metrics) |
| Mkt-Sum-Transactions | may represent the total number of trans- |
| | actions completed by Buyers, Sellers and |
| | Traders via all EMarketplaces |
| Mkt-M-Dollars-Traded | may represent the number of dollars spent |
| | on all EMarketplaces by Buyers, Sellers |
| | and Traders carrying out trades |
| Customization | may represent user-supplied estimate |
| | (scale of 1-10) of relative character of |
| | Trade Items as to customized or |
| | commodity |
| Volatility | may represent user-supplied estimate |
| | (scale of 1-10) of relative volatility of |
| | Market supply and demand due to non- |
| | seasonal factors |
| Seasonality | may represent user-supplied estimate |
| | (scale of 1-10) of relative importance of |
| | volatility due to seasonal factors |
| Branding | may represent user-supplied estimate |
| | (scale of 1-10) of relative importance of |
| | branding of Trade Items to pricing |
| Relationship | may represent user-supplied estimate |
| | (scale of 1-10) of |
| | relative importance of relationships, such |
| | as long-term contracts to pricing |
| Technology-Adoption | may represent user-supplied estimate |
| | (scale of 1-10) of relative adoption by |
| | Market of Information Technology, such |
| | as PCs, Internet |
| PopulationRules | May be behavior modules for generating |
| | statistical distributions of Player |
| | populations as alternatives to override the |
| | default Normal/Gaussian distribution |
| PerCentMembershipOverlap | May represent max and min allowed |
| Max and Min | overlap on charter members when |
| | populating EMarketplaces |
| MaxNmbrMemberships | May be integer constraining the maximum |
| | number of EMarketplaces to which a |
| | business may belong |

TABLE 3
Exemplary Attributes for LineOfBusiness

| Attribute | Description |
|---|---|
| Name | may be used to track instance by symbolic |
| | identifier |
| Market-Share | may represent percentage of market owned |
| | by this player |
| Buy-Transactions- | for Buyers and Traders, may represent the |
| Allocated-to- | number of transactions reserved for |
| EMarketplaces[] | EMarketplaces s) within this particular |
| | market, by Trade Item |
| Sell-Transactions- | for Sellers and Traders, may represent the |
| Allocated-to- | number of transactions reserved for |
| EMarketplaces[] | EMarketplaces (s) within this particular |
| | market, by Trade Item |
| Sell-Commitment[] | may represent the percentages of supply |
| | liquidity (i.e., transactions) Sellers and |
| | Traders commit to given EMarketplaces, by |
| | Trade Item |
| Buy-Commitment[] | may represent the percentages of supply |
| | liquidity (i.e., transactions) Buyers and |
| | Traders commit to given EMarketplaces, by |
| | Trade Item |
| Transactions-Sell [] | may represent the number of sell transactions |
| | completed by Sellers and Traders on given |
| | EMarketplaces, by Trade Item |
| Transactions-Buy [] | may represent the number of buy trans- |
| | actions completed by Buyers and Traders on |
| | given EMarketplaces, by Trade Item |
| Transaction-Failures [] | may represent the number of attempted |
| | transactions not completed by Buyers, |
| | Sellers, and Traders on given EMarketplaces, |
| | by Trade Item |
| Money-EMarketplaced- | may represent the number of dollars spent on |
| Sell [] | given EMarketplaces by Sellers and Traders, |
| | by Trade Item |
| Money-EMarketplaced- | may represent the number of dollars received |
| Buy [] | for purchase transactions of Trade Items on |
| | given EMarketplaces by Buyers and Traders, |
| | by Trade Item |
| Sourcings-Allocated- | for Buyers and Traders, may represent the |
| toEMarketplaces[] | number of Sourcings (product, partner |
| | searches) reserved for EMarketplace(s) |
| | within this particular market, by Trade Item |
| Sourcings-Committed- | may represent the percentages of sourcing |
| toEMarketplaces[] | liquidity (i.e., searches for partners/products) |
| | Buyers and Traders commit to given |
| | EMarketplaces, by Trade Item |
| Sourcings-Completed [] | may represent the number of sourcing |
| | actions completed by Buyers and Traders on |
| | given EMarketplaces, by Trade Item |
| Sourcings-Failures [] | may represent the number of attempted |
| | sourcings not completed by Buyers, Sellers, |
| | and Traders on given EMarketplaces |
| Percentage-New-Sourcing | may represent the percentage of trades |
| | completed by Buyers, Sellers, and Traders |
| | on given EMarketplaces that involve |
| | sourcing for new vendors as opposed to |
| | contract-based trading with existing partners, |
| | by Trade Item |
| TradeItems-to-Buy [,] | may represent different Products and |
| | Services (or categories of same) purchased |
| | by a given Buyer or Trader, on given |
| | EMarketplaces |
| TradeItems-to-Sell [,] | may represent different Products and |
| | Services (or categories of same) sold by a |
| | given Seller or Trader, on given |
| | EMarketplaces |
| Buyer-Partners | may represent Buyer or Trader partners on |
| | given EMarketplaces, by Trade Item |
| Tenure [] | may represent the number of cycles, |
| | measured consecutively, that a Buyer, Seller, |
| | Trader has belonged to a given |
| | EMarketplace. |
| Seller-Partners | may represent Seller or Trader partners on |
| | given EMarketplaces, by Trade Item |
| Trust [] | may represent a quantitative measure of the |
| | trust (good faith, credibility) placed in given |
| | EMarketplaces by Buyers, Sellers, and |
| | Traders based on past experience and |
| | EMarketplace services and reputation |
| Color [] | may be used to color code liquidity |
| | commitments to EMarketplaces by Buyers, |
| | Sellers, and Traders |
| Generated? | may indicate whether or not a Buyer, Seller, |
| | or Trader was statistically generated (True) |
| | or created from actual business-specific data |
| | (False) |
| Trading Rules [,] | may identify the business rules associated |
| | with this party on a given EMarketplace |
| Search-Cost | may represent computing values for a |
| Contracting-Cost | particular company on costs for overhead |
| Coordination-Cost | contributions to overall transaction value, |
| | used in Determine-Membership-Changes |
| Business-Factor- | may be assigned in Setup-Market-Member, |
| Dispersion | and may be used to vary the EMarketplace- |
| | level weighting factors assigned to Content, |
| | Commerce, and EMarketplace services by a |
| | company in making its decision via |
| | Determine-Membership-Changes. The |
| | attribute may hold this randomly assigned |
| | factor as constant, so that a given business |
| | applies the same decision criteria uniformly |
| | across Period-to-Evaluate iterations |
| Service-Factor-Weight | may be weighting factor set for Buyers, |
| | Sellers, Traders that determines how they |
| | weight the importance of EMarketplace |
| | value proposition components, used in |
| | Determine-Membership-Changes method |

TABLE 4
Exemplary Attributes for EMarketplaces (B2B Marketplaces)

| Attribute | Description |
|---|---|
| Name | may be used to track instance by symbolic |
| | identifier |
| Market-Share | may represent percentage of market owned by |
| | this player (EMarketplace), by Tradeitem |
| Nmbr-Charter-Buyers | may track number of Buyers/Sellers/Traders |
| Nmbr-Charter-Sellers | created from Imported Data |
| Nmbr-Charter-Traders | |
| Mean-Buy-Commitment | may represent user supplied estimates of mean |
| Mean-Sell-Commitment | percentage of supply and demand (total |
| Mean-TraderBuy- | purchases or sales) Parties allocate or reserve |
| Commitment | for the EMarketplace, by Trade Item |
| Mean-TraderSell- | |
| Commitment | |
| Buy-Commitment- | may represent representing user supplied |
| Dispersion | estimates of one standard deviation from mean |
| Sell-Commitment- | in distribution of commitments across Parties |
| Dispersion | allocating transactions to the EMarketplace, by |
| Trader-Commitment- | Trade Item |
| Dispersion | |
| Transactions-Sell | may represent the total number of sell trans- |
| | actions completed by Sellers and Traders on |
| | this EMarketplace, by Trade Item |
| Transactions-Buy | may represent the number of buy transactions |
| | completed by Buyers and Traders on this |
| | EMarketplace, by Trade Item |
| Transaction-Failures | by Buyers, Sellers, and Traders on this |
| | EMarketplace, by Trade Item |
| Money-EMarketplaced- | may represent the number of dollars spent on |
| Sales | this EMarketplace by Sellers and Traders, by |
| | Trade Item |
| Money-EMarketplaced- | may represent the number of dollars received |
| Purchases | for purchase transactions of Trade Items on this |
| | EMarketplace by Buyers and Traders, by Trade |
| | Item |
| Products-to-Sell [] | may represent union of different products (or |
| | product categories) available to Buyers or |
| | Sellers on this EMarketplace |
| Services-to-Sell [] | may represent union of different services (or |
| | service categories) available to Buyers or |
| | Sellers on this EMarketplace |
| EMarketplace-Type | may represent category of business model for |
| | EMarketplace |
| TradingRules [] | may identify the business rules associated with |
| | this EMarketplace governing trading (e.g., |
| | Make-Demand-Trades for catalog purchases), |
| | membership restrictions, policies, etc., |
| | by Trade Item |
| Revenue-Model | may identify sources of revenue for |
| | EMarketplace (transaction fees, subscription |
| | fees, advertising, outsourced business |
| | processes, etc.) |
| Mean Nmbr trading | may identify number of trading partners from |
| ptnrs for: | within a given marketplace (e.g., Sellers & |
| Buyers | Traders for Buyers) with which a business |
| Sellers | trades on a recurring, preferential, dedicated |
| Buy partners for Traders | basis. (If these values are 0, most trading |
| Sell partners for Traders | models assign counterparties at random |
| Percentage of trade | may represent user supplied estimates of the |
| dedicated to trading | percentage of trade that a business allocates |
| ptnrs for: | to its trading partners. This % will be reserved |
| Buyers | for partners; the rest will be assigned at random |
| Sellers | from the pool of available counterparties, |
| Buy partners for Traders | including trading partners preferential, |
| Sell partners for Traders | dedicated basis. (If these values are 0, most |
| | MarketDynamics trading models assign |
| | counterparties at random |
| Percentage dispersion | may represent user supplied estimates of one |
| | standard deviation from mean in distribution |
| | across population for percentage of trade |
| | dedicated to trading partners |
| Percentage of trade | representing user supplied estimates of the |
| dedicated to trading | percentage of trade that a business allocates to |
| ptnrs for: | its trading partners. This % will be reserved for |
| Buyers | partners; the rest will be assigned at random |
| Sellers | from the pool of available counterparties, |
| Buy partners for Traders | including trading partners preferential, |
| Sell partners for Traders | dedicated basis. (If these values are 0, most |
| | trading models assign counterparties at random |
| Failure-Rate-Search | may represent user-supplied estimated |
| Failure-Rate-Transact | percentages of failure in how the EMarketplace |
| Failure-Rate-Fulfill | performs with respect to enabling trading |
| Failure-Rate-Other | parties to find one other, carry out trades, |
| | fulfill trades, and support other services. |
| Weight-Search-Fail | may represent user-supplied estimates of the |
| Weight-Transact-Fail | relative importance of each of these failure |
| Weight-Fulfill-Fail | factors to current EMarketplacemembers (used |
| Weight-Other-Fail | in Decide-Continuation-Behavior) |
| Period-to-Evaluate | may represent the period (in number of cycles) |
| | after which EMarketplace members and other |
| | Market players assess their positions with |
| | respect to the EMarketplace (triggers engine to |
| | invoke Update-Players) |
| Content, Commerce, | may represent user-supplied estimates of the |
| Community, | EMarketplace's capability to deliver |
| Collaboration, Customer- | eCommerce service categories to its members |
| Relationship- | in these categories (which are being |
| Management | decomposed into finer-grained functional |
| | components); may be used along with |
| | EMarketplace liquidity in Determine- |
| | Membership-Changes |
| Liquidity-Weight | may represent user-supplied estimates of the |
| Content-Weight | relative importance of each of these |
| Commerce-Weight | eCommerce service categories to prospective |
| Community-Weight | EMarketplace members (may be used in |
| Collaboration-Weight | Determine-Membership-Changes) |
| CRM-Weight | |
| Business-Factor- | may be specified by user setting; may be used |
| | as input to random number generator to assign |
| | Business Factor-Dispersion values to each |
| | business in Setup-Market-Member. These |
| | values may be subsequently used by Businesses |
| | in Determine-Membership-Changes to decide |
| | whether to join an EMarketplace or not. |

TABLE 5
Exemplary Attributes for Trade Item Products

| Attribute | Description |
|---|---|
| Name | may be used to track instance by symbolic identifier |
| Category | may represent a product category |
| Part-Number | may be used by Manufacturer to identify this product |
| Description | textual description |
| Units per package | may represent the number of units in package |
| Cost | may represent the base cost of the product to buyers in |
| | U.S. Dollars |
| Shipping | may represent shipping restrictions |
| Requirements | |
| Customization | may represent user-supplied estimate (scale of 1-10) of |
| | relative character of Product as a Custom-made or |
| | Commodity item |
| Perishability | may represent user-supplied estimate (scale of 1-10) of |
| | relative perishability of Product (e.g., produce, fashion |
| | goods, drugs) |
| Rules [] | may identify the business rules associated with product |
| | on a given EMarketplace governing its trading |
| Product-specific | Specialized descriptors, as may be required |
| attributes | |

### Simulation Technique Overview

One exemplary design for the dynamic simulation engine in one embodiment of the invention synthesizes the techniques of parallel discrete event simulation, Monte Carlo programming and CAS simulation technology.

In this embodiment, the decision model is implemented directly as a collection of agents or automata, representing EMarketplace, LineOfBusiness, ServiceOffering, and Event object classes, as defined hereinabove. These entities are instantiated at run-time in memory associated with the simulator engine process, as autonomous objects with attributes and behaviors. These domain objects were previously created by analyst users with the GUI domain modeling tool and saved to the repository. The contents of these objects are primarily declarative attributes, comprising symbolic strings (e.g., name), numerical data, or lists (arrays) of such elements. When loaded back into memory, these instances inherit the class-level behaviors defined in the modeling framework. These behaviors are object-oriented procedural methods—code modules such as decision or event rules—that operate on attribute values, described in more detail in Tables 6 through 10 hereinbelow. Alternate embodiments may use non-object-oriented representations of some or all of these model constructs. For example, trade items and economies could be represented as symbolic values (names, quantities) in global variables or agent attributes, rather than being depicted as explicit object classes in their own right.

One embodiment of the simulation framework subsystem of the present invention comprises a controller program that creates, manages, and invokes the market model entities. The controller is a classical parallel discrete-event simulation engine comprising a clock, event queues, queue management facilities, and a control loop. (See, e.g., Law and Kelton) The control loop constitutes the heart of the execution engine, directing initialization and all subsequent simulation tasks. Typically, initialization results in the posting of one or more application activities to a queue. Each activity represents a bounded task or “discrete event” that is assumed to be more or less independent of other events. The control loop then dequeues each item serially and executes it. In the course of executing activities, additional activities may be posted to the queue. The queue manager keeps track of when the tasks are posted. It terminates a cycle when all tasks posted prior to that cycle are completed and interacts with the control loop to begin another cycle based on the current queue contents, and so on.

A parallel discrete event simulation engine operates in an analogous manner. However, the parallel engine interprets each event as an activity that applies to a collection of similar model entities, variously called instances, agents, cellular automata, or bots. The engine invokes the given event or instruction against all relevant model constructs before proceeding to the next instruction or cycle. Execution may simulate parallelism, on a single processor, or may actually occur literally simultaneously, across a network of interconnected, replicated computers. Engines vary in their approach towards potential interactions among parallel activities. The programming language may provide constructs that explicitly guarantee independence or may assume that the programmer designs the activities to avoid mutual interference. (Suppose, for example, that an activity has a “side-effect,” such as changing the value of a global variable representing the total number of trades completed. If all the agents making trades at the same time attempt to update that variable, their updates against the same datum might interfere with one another, resulting in an inaccurate tally. The engine may “lock” or “reserve” that variable to one agent at a time, ensuring proper serial updates through built-in language support, or require programmers to manage the locking and unlocking on their own, as the application may require.)

In one embodiment of the present invention, the simulation engine operates against populations of agent objects corresponding to instances of the modeling framework described in FIG. 4 and Tables 1 through 5. The primary active objects for the business domain simulation in the current embodiment are EMarketplaces and LinesOfBusiness. Supporting agents include environmental objects—Economy, Markets, and related objects such as Events, EServiceOfferings, and TradeItems. These agents all possess built-in behaviors, implemented as object methods. However, EMarketplaces and LinesOfBusiness represent the primary active players in this decision domain and embodiment, whereas the other objects are passive or reactive: their behaviors change their internal state, but only in response to active player behaviors or environmental modifications.

The engine exercises an overall application control flow that drives the simulation of an Economy and its constituent players Markets, LinesOfBusiness, given a particular scenario that specifies anticipated trends and events in the target decision domain, and supporting simulator control settings. Based on this control logic, the controller invokes particular sets of pre-programmed behaviors, on particular sets of agents in a determinate order.

In one embodiment, the simulation engine executes individual instructions within procedures for all agents of the given type in parallel, before moving onto the next instruction, which is applied in parallel again, and so on. The engine incorporated into the application consistent with the invention may transparently maintain synchronization of state, managing state based on the built-in semantics of its programming language. The engine may maintain both global state (e.g., market-wide variables) and local state (attribute values specific to particular sellers or EMarketplaces) within and across execution cycles. Other embodiments of the simulation engine may invoke an entire behavior in one agent before invoking that behavior in its entirety in the next agent, and so on. This approach entails a different kind of synchronization control to ensure integrity of state information across agents.

In essence, a control flow augments or customizes the simulation engine qua generic simulation framework with logic specific to particular decision domain, its players, and their behaviors. Thus, the embodiment for B2B decisions incorporates simulator control of B2B EMarketplaces and LineOfBusiness behaviors pertaining to Trading and other ServiceOfferings. Other embodiments, for example for mergers and acquisitions, would include other active players, such as Regulators and key corporate Executives, and behaviors that simulate participation in regulatory processes, decisions to stay with or leave a company subject to reorganization, and processes to modify business alliances.

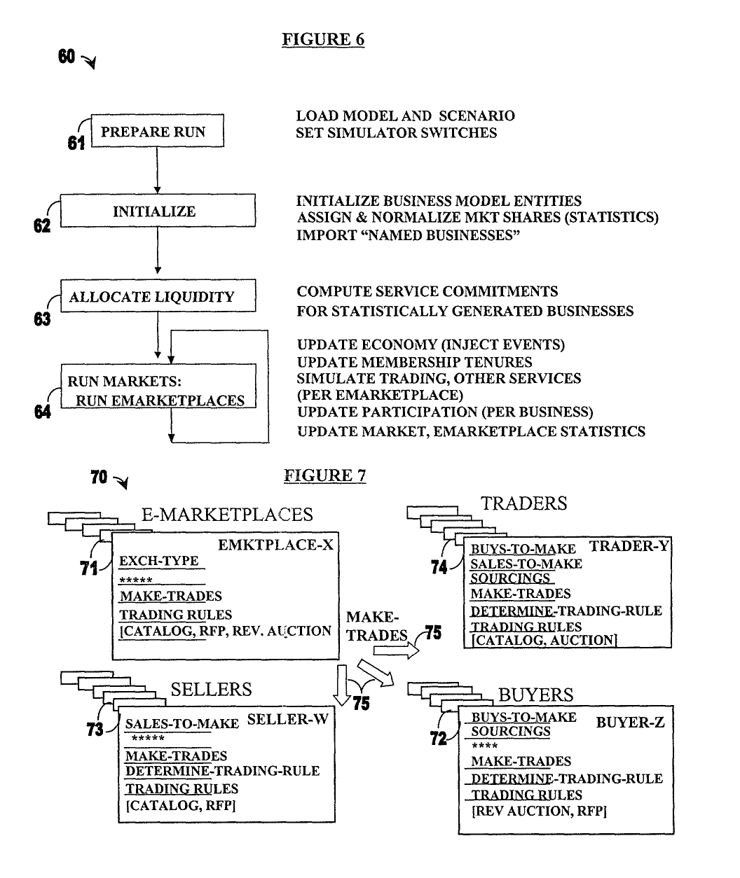

FIG. 6 illustrates an exemplary top-level control flow 60 for the parallel discrete event simulation engine in a B2B EMarketplace embodiment of the invention. First, the simulation run is prepared 61, by loading the selected domain model and scenario into memory, including the Economy, and constituent Market, EMarketplace, (named) LineOfBusiness, Event and supporting object instances. Also included in this step will be the initialization of values of the simulation engine switches required for graphical display and instrumentation settings that drive the execution trace for monitoring and log recording purposes.

Next, the decision model is initialized 62. Included in this step are the Monte Carlo programming steps that create the relevant populations of LineOfBusiness instances within the target Market(s); assign and normalize market shares for LinesOfBusiness for the TradeItem(s) in the given Market; assign other statistically generated attribute values, such as Liquidity commitments of LinesOfBusiness to buy and sell TradeItems in particular EMarketplaces. The scenario defines the relevant statistical information—distribution type, mean, dispersion—necessary to generate the population values. Additional logic is applied to normalize values so that market shares and percentage-based liquidity commitments sum to 100 across the relevant populations.

Next, liquidity is allocated 63. Included in this step may be the computation of the supply and demand commitments of LinesOfBusiness (by Buyer, Seller, and Trader roles for particular TradeItems) to the EMarketplaces in which they participate for trading. Some of these commitments are derived from statistical (player-by-population) specifications, while other commitments are derived from explicit player-by-name inputs from analysts. These values establish the trading profiles for EMarketplace members, in terms of commitments to perform average numbers of buy and sell transactions per trading cycle, as appropriate to agent types or roles (pure Buyers only buy, whereas Traders both buy and sell). Following this member-level computation, this step also computes aggregate market shares and expected transaction rates for the EMarketplaces.

Finally, the simulation engine enters a repeating process to run the EMarketplaces operating with each Market 64. This step loops continuously over a set of cycles, which typically represent individual business days. A cycle may be set to some other “atomic unit” such as a month or week. For example, in thinly traded EMarketplaces, a trading day represents an overly granular measure for business activity, and should be replaced by a unit such as a week or month to gather more useful performance metrics.

The core processing for each cycle is to invoke a sequence of behavioral rules (algorithms) against the decision model active players. In the B2B embodiment, the active players are EMarketplaces and LinesOfBusiness. Therefore, the control loop invokes the Run EMarketplace behavior on all EMarketplaces within each Market. Run EMarketplace, in turn, invokes other behaviors, in parallel, on the member LinesOfBusiness, including trading and Update-Players.

At the start of each cycle, the Economy is updated, which is accomplished by checking the event queue. For any cycle N, if any events are scheduled to occur in that cycle (t=t_{N}), then the rule associated with this event will be applied. Event rules modify values of market, EMarketplace, and business level attributes, basically applying the anticipated macro-level economic and intentional effects caused by the event. For example, an event such as a natural disaster that disrupts supply or delivery of raw materials or products can be anticipated to cause price increases and decreased transaction volumes. “Timely” events are removed serially from the event queue and their event rules are applied to modify the decision model state.

Next, LinesOfBusiness update their tenure in any EMarketplaces in which they participate. Tenure is measures in cycles (atomic units such as trading days or months) of continuous membership. A LineOfBusiness is considered a member, and its tenure updated, if it has ongoing non-zero liquidity commitments or subscriptions to one or more ServiceOfferings for a given EMarketplace at the start of a cycle. A LineOfBusiness may make use of Sourcing and/or Trading services, Content or Community, or other ServiceOfferings available from a given EMarketplace.

Third, all EMarketplaces within the given Market(s) are invoked to run the core domain simulation algorithm, Run EMarketplace. This behavior executes the relevant trading model(s) and related ServiceOfferings for member LinesOfBusiness. EMarketplace, LineOfBusiness, and TradeItem attribute values and behavioral rules determine these. In the initial B2B embodiment, Run EMarketplace invokes Sourcing behavior (wherein LinesOfBusiness find new trading partners), Trading behavior, and an Update-Player behavior, which periodically adjusts LinesOfBusiness participation in EMarketplaces.

For example, the Make-Demand-Trades module, discussed in further detail hereinbelow, implements an aggregator or catalog-based trading strategy. This model corresponds to a catalog-based trading mechanism, in which purchasers determine their trading quota, seek out suppliers of goods and services, initiate trades based on fixed prices, factoring in failure rates, select a partner, and complete the trade. Other exemplary EMarketplace trading algorithms may simulate auctions, RFQs, bid-ask, and negotiations. Marketplaces and agents may be extended with rules that govern who trade what items under what conditions. For example, surplus commodity items might be traded through auctions, whereas complex products or services might be traded via negotiations or RFQs.

FIG. 7 is a flow diagram illustrating the invocation of trading behavior 70 by EMarketplaces on their member businesses, in one embodiment of the invention. As shown, EMarketplaces 71 may control the execution of trades. Trading rules may be applied to particular trades according to the following model. EMarketplaces 71 have trading rules, which may correspond to the trading models that they support (e.g., catalog, request for proposal, auction). Buyers 72, sellers 73, and traders 74 may also have trading models, which represent the models in which they are willing to participate (e.g., sellers may not want to participate in reverse auctions that may tend to drive prices down). At trading time, the Markets instruct each of their constituent EMarketplaces 71 to make trades for a particular trading cycle. EMarketplaces 71 may send Make-Trade messages 75 (method calls) to LinesOfBusiness in Trader 74, Seller 73, and Buyer 72 trading roles. These entities may then apply the logic in DetermineTradeRules to figure out what rule/model to apply in buying or selling particular goods.

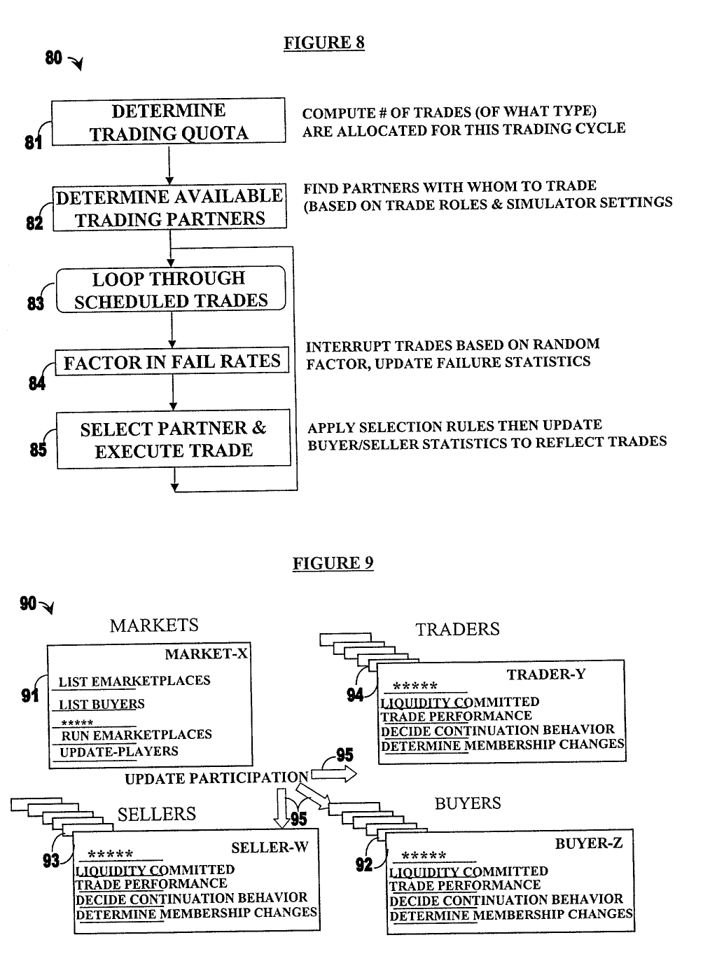

The exemplary trading model or rule mentioned above, called the Make-Demand-Trades algorithm 80, is depicted in FIG. 8. This model 80 corresponds to a catalog-based or “aggregator” trading mechanism, in which purchasers (Buyers and Traders in buying mode) determine their trading quota 81, seek out suppliers of goods and services (Sellers and Traders in selling mode) 82, initiate trades 83 based on fixed prices, factoring in failure rates 84, and select a partner and complete the trades 85. In this model, the liquidity allocation performed in step 63 of FIG. 6, as discussed above, may be interpreted as follows: Lines of Business in trading roles of Buyer and Traders in their buying mode for a given TradeItem assume active roles. By allocation, they have committed to perform a certain number of purchases of the TradeItem on average, per day. The execution engine invokes these agents (in parallel) for their profiled quota of transactions, which be realized as simulated catalog search and fixed-price purchases. In this trading model, Sellers (and Traders in their selling mode) play passive roles, recording sales transactions, but never initiating trades. Since Sellers and Traders are passive in Make-Demand-Trades, liquidity allocation only represents the expectation on the part of Sellers to engage in that number of transactions. This expectation comes into play in Seller decisions on continued participation in marketplaces. Reflecting the role of Traders (e.g., distributors or brokers in a market), Traders may make their purchases from suppliers first, and then act as (passive) Sellers to pure Buyers.

Make-Demand-Trades is a modular algorithm. Other models may include request for proposal (RFP) and auctions. In an RFP model, buyers may post notifications of intent to buy specified goods (either broadcast or delivered specifically to a pre-qualified set of vendors). The vendors who are interested may reply with a trading proposal. The Buyers may then evaluate the proposals, select one or more winners, and complete the trades.

Returning to FIG. 6, once EMarketplaces exercise their ServiceOfferings for member LinesOfBusiness, several update behaviors are invoked to finish up each processing cycle. Some of these behaviors are run conditionally, based on simulator switch settings. In other words, some behaviors are only run periodically, such as quarterly or monthly (after a certain number of cycles has passed), reflecting real-world business behaviors.

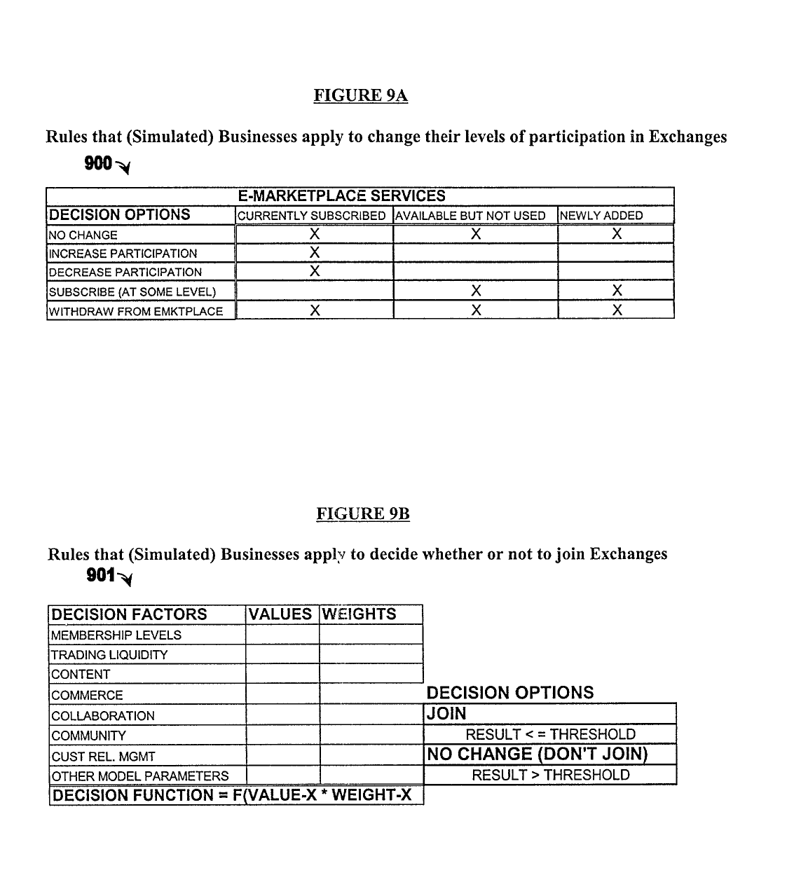

In the B2B EMarketplace decision domain embodiment, two prominent examples are LineOfBusiness behaviors to periodically re-assess their continued participation (or lack thereof) in the B2B EMarketplaces available in the given market, as illustrated in FIG. 9. At each cycle corresponding to the decision period setting, each Market 91 instructs its member LinesOfBusiness to assess their participation in the available EMarketplaces 95. They do this by applying rules DecideContinuationBehavior and DetermineMembershipChanges. In this embodiment, the rule logic differs depending upon the trading role of the LineOfBusiness with respect to TradeItems in the given EMarketplaces—Buyer 92, Seller 93, or Trader 94.

FIG. 9A illustrates one embodiment of DecideContinuationBehavior 900. All LinesOfBusiness that currently belong to an EMarketplace (i.e., have non-zero tenure as described hereinabove) apply decision rules that assess their performance records on service utilization and other criteria, and determine whether they want to adjust their levels of participation in that EMarketplace. Rule conditions compute different values based on Trading Roles for TradeItems. With respect to a given EMarketplace, a LineOfBusiness may currently subscribe to a service at some level of commitment (e.g., attempt to execute X Buy or Sell trades); may choose not to subscribe to a service, or may not subscribe because that service has hitherto been unavailable but is now offered as of the current cycle. Based on the rule-based computation, a LineOfBusiness may maintain its current levels of participation; increase participation (e.g., allocating 10% more of their purchases to the EMarketplace); decrease participation (e.g., allocating 10% less commitment of purchases or sales to the EMarketplace), or withdraw from the EMarketplace entirely. (e.g., setting commitments to zero and leaving the EMarketplace). The exemplary DecideContinuation algorithm is implemented as a modular conditional rule construct: IF certain conditions then enact one of the four options described above, ELSE IF, etc.). Antecedent clauses typically compute values such as the ration of successful trades to unsuccessful ones and comparing them against threshold values. Consequent clauses update participation levels. Different LinesOfBusiness may adopt different rules as assigned by the analyst user in the Scenario at decision model definition time.

FIG. 9B illustrates one exemplary approach 901 to applying decision rules for determining membership changes. All LinesOfBusiness that do not belong to an EMarketplace may periodically re-evaluate their earlier decisions not to join. This decision may reflect considerations including current membership levels and liquidity, the ServiceOfferings available from the EMarketplace, and other factors, e.g.: costs to join a marketplace, costs to do business via the marketplace, costs to do business in-house or elsewhere (These factors reflect economist Ronald Coase's theory of enterprise activities vs. outsourcing.) Benefits of membership may be categorized along the following dimensions: content, community, collaboration, and commerce. Liquidity of the marketplace may be determined relative to the entire industrial market. All of these factors may be specified, to varying degrees of detail, within the set-up process. Users may also assign weights to bias the relative contribution of each factor to the decision; that is, how important a factor is compared to other factors. This embodiment implements the decision algorithm as a conditional rule that computes an aggregate value, compares it to some threshold, and then issues a join/do not join result based on that comparison. Different players may adopt different rules from the library. Once LinesOfBusiness update their decisions, their state and the roster of EMarketplaces, which is derived from LineOfBusiness subscription information, may be updated to reflect these membership changes.

Returning to FIG. 6, once the players are updated at the end of a cycle, another periodic update behavior may be invoked on Markets. Following this, aggregate statistics for EMarketplaces are computed (e.g., trades completed, changes in overall liquidity), and the cycle terminates.

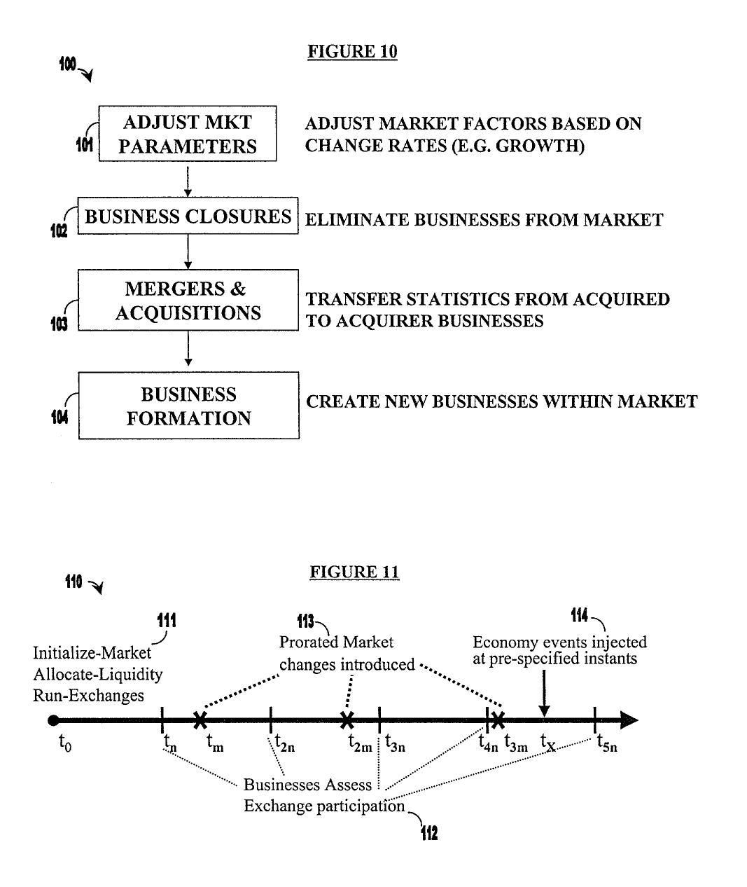

FIG. 10 illustrates an exemplary behavioral algorithm 100 for updating Markets in one embodiment of the invention. This algorithm embodies the adaptive behavioral elements of the simulation engine consistent with the present invention, a key aspect of the dynamism of the modeling and analysis of the invention. In addition to micro-level changes (LinesOfBusiness, EMarketplaces), embodiments of the invention may also capture broader level evolution at the macro-level, pertaining to the overall economy and to the industrial markets that operate within it, consistent with economic theory.

Market-level changes may include new business formation, business closure, mergers and acquisitions, and regulatory changes. These changes may be captured parametrically at scenario definition time, primarily in terms of annual rates of change from existing values. Updates to the market populations (buyer, seller, trader, EMarketplace) and market-level state (e.g., annual transaction rate) may be applied to the market model periodically, after a specified number of execution cycles have taken place. It is noted that the periodicity of macro-level updates may be varied independently from the periodicity of the micro-level adaptations.

The specific algorithm may apply the following changes in the exemplary order set forth hereinbelow: It is noted that all changes may be applied by pro-rating the annual rates of change corresponding to the market-update period. For example, if the update period is 30 (days), then the factor applied on every iteration may be multiplied by 30/365 days in the year. It is further noted that a potential problem may arise if the market-update-period and annual rate of change are low, because the floating point number may be rounded down (i.e., truncated) to the nearest integer by default. In this case, a special adjustment may be made so that minimal change still occurs. A similar problem may occur and be resolved in adjust supply/demand/trader liquidity methods. An exemplary order for applying changes may be: adjusting 101 the number of transactions per year in the market to reflect market growth or shrinkage; eliminating 102 some LinesOfBusiness (chosen randomly across trading roles) to reflect the rate of business closures; merging 103 some LinesOfBusiness (resulting in consolidation of liquidity and market position from the acquired company into the acquiring company, followed by the extinction of the acquired), wherein the type of business may be chosen randomly across trading roles and creating 104 new LinesOfBusiness, again, by random choice of business Trading Roles—Buyer, Seller, or Trader. Following the injection of these changes, market-shares for the buyers, sellers, and traders may be re-normalized and their states may be reset through the Allocate Liquidity behaviors (on a second—as opposed to a first-time basis) 63. This model for updating Markets may be extensible in a straightforward manner to reflect other Market— and Economy level factors, such as the annual rate of change in mean-transaction-size, and changes in the annual rates of inflation, commodities, productivity, and corporate taxation, in addition to regulatory changes that necessitate changes in business process and policy. In general, new parameters may be added to capture the given factors, and then the update-market method may be extended as appropriate to change populations, member attribute values, or business rules.

The simulation of economic behavior in the present invention is necessarily somewhat complex because of the various kinds of change it models. FIG. 11 summarizes an exemplary overall timeline 110 of simulation engine behaviors in one embodiment of the invention, as described hereinabove with reference to FIG. 4. At t_{O} 111, the simulation starts and the primary Run-Market/EMarketplace loop is initiated. The engine then iterates through some number of cycles, based on user control or preset switch values. At periodic intervals, businesses may assess 112 their participation in an EMarketplace. At other intervals, pro-rated market changes may be introduced 113 into the model (reflecting annual growth rates, etc.). Finally, events may be injected 114 into the model at particular instants that are specified when the events are defined. The simulation engine's execution monitoring and control facilities, as exposed to users through a simulator GUI, have already been described and illustrated hereinabove.

Tables 6 through 10, below, further detail exemplary specifications of the simulation framework in an exemplary B2B EMarketplace embodiment of the invention. These specifications, represented in tabular format, capture the detailed declarative structure of the simulator and domain model class behaviors comprising the execution model. Table 6 summarizes the key attributes used by an exemplary simulation engine and display consistent with the present invention. Table 7 enumerates and describes exemplary behaviors (procedural methods) for the Economy 42. Table 8 enumerates and describes exemplary behaviors for the Market 43 class. Table 9 enumerates and describes exemplary behaviors for the EMarketplace class 44. Table 10 enumerates and describes exemplary behaviors for LineOfBusiness class 45 in different Trading roles.

TABLE 6
Exemplary Attributes for Simulation Engine

| Attribute | Description |
|---|---|
| Cycle | may be used to track elapsed time units (generally, |
| | trading days) in the context of the running execution |
| | engine. |
| Graphics variables: | may be coordinates for icons representing businesses |
| Buyer-Origin-X | on screen. For Buyers and Sellers (Trust = X-axis |
| Seller-Origin-X | and Liquidity y-axis), while for Traders, the |
| Trader-Origin-X | coordinates are reversed |
| Trader-Origin-Y | |
| Buyer-Color | |
| Seller-Color | |
| Trader-Color | |
| EMarketplace- | |
| Color | |
| Control Flags: | may control display of trace, debug and error |
| Trace?, Debug?, | statements |
| Error? | |
| EventsList | Events may enable the definition of “real-world” |
| | events, such as wars, natural disasters, or materials |
| | shortages, that invariably effect national and global |
| | economies, individual markets, and the businesses |
| | that operate in those contexts. |
| | An event may have a unique identifier, a name, a |
| | description, and a time of occurrence. The time of |
| | occurrence of an Event may be an integer that |
| | represents the trading cycle (simulated time) at |
| | which the engine injects the event into the model. |
| | Actual events such as wars have extension over |
| | time. The invention groups sequences of discrete |
| | events into extended sequences using Episodes. |
| | Events are related to one another by pointing to a |
| | common Episode The final datum may specify |
| | which rules the execution engine should apply to |
| | represent the effects of the given event in the |
| | Economy and Markets, which ultimately may affect |
| | the EMarketplaces and businesses in the Markets. |
| EventRulesList | representing pointers to rules. Event rules may |
| | represent the mapping of events into the Economy, |
| | Markets, and Businesses. An event, per se, has no |
| | intrinsic impact on the domain model. Event rules |
| | may fill the role of specifying how that event |
| | changes the Economy, Market, and Businesses. |
| | Rules may be implemented as code modules, such |
| | as object methods. Each such module may inject |
| | changes into a particular model by changing model |
| | parameter values. The event's time-of-occurrence |
| | may dictate when that code module is invoked (by |
| | Update-Market), which may determine when those |
| | changes are introduced into the model. For example, |
| | a rule for serious commodity shortage events might |
| | increase the annual rate of inflation (an Economy |
| | level parameter) as well as increase the price of the |
| | commodities, and the cost for goods that depend on |
| | that commodity (Product level parameters) |

TABLE 7
Exemplary Behaviors for Economy

| Procedural | |
|---|---|
| Method | Description |
| Trace-Globals | Procedure may output Economy-level parameter settings |
| | to Log Trace in CSV format |
| Import- | Method may import data characterizing specific Markets, |
| Member-Data | Scenarios, and the Economy from the Repository |
| | (Markets are never generating automatically). Basically, |
| | may be a control loop to read Repository data and create |
| | the relevant instances. |
| | May invokes Load-Economy-Data to transfer relevant |
| | data into instance member variables, update Market |
| | counters |
| Import- | Method may load data characterizing EMarketplaces, |
| EMarketplace- | their charter membership, their statistics, and service |
| Data | offering, either from the GUI controls (for one |
| | EMarketplace) or from list of imported user |
| | specifications. |
| Load- | May take an array of user-supplied data characterizing a |
| Economy-Data | Market, a Scenario, or the Economy, and populate the |
| | appropriate member attributes of the relevant instances. |
| Initialize- | May clean up the Simulator engine state from previous |
| Economy | runs, |
| | May perform initializations: may set global variables, |
| | including Log/Debug/Error flags, trading time interval, |
| | initial display settings (coordinate origins and color |
| | values), and the Market entity counters. |
| | May import user-specified Economy and Market level |
| | data |
| | May set up Graphic Displays (clears Log window, call |
| | Setup-Graph to create and initialize Plot Windows, |
| | initialize Display-Windows and monitor controls) |
| | May create Model entities (Markets and Scenarios) |
| | May initialize Market instances (via Initialize-Market |
| | calls) |
| | May perform rule-based error checking on parameter |
| | values to ensure model and scenario consistency |
| Run-Markets | May be Primary (top-level) Control loop for Dynamic |
| | Simulation. |
| | May check market-level error flags |
| | May update global Cycle counter (representing passage |
| | of atomic time unit, e.g., trading day) |
| | May check the EventsList to determine if any event |
| | Time-of-Occurrence matches the current cycle. If so, |
| | may call Update-Economy to apply rules for |
| | May invoke Run-Market method on individual Markets |
| | direct the secondary control loops. These Market-level |
| | loops may then drive EMarketplace-level simulation of |
| | trading and other EMarketplace-specific services. |
| Update- | May be called by Run-Markets immediately after cycle |
| Economy | counter is incremented. May check for events with |
| | time-of-occurrence matching cycle value. If so, may |
| | invoke Apply-Event-Rules and pop Event from |
| | Events-list |
| Apply-Event- | May be called by Update-Market. May execute specified |
| Rules | rules, which modify Economy, Market, and |
| | EMarketplace level parameters, as specified. |

TABLE 8
Exemplary Behaviors for Markets

| Procedural | |
|---|---|
| Method | Description |
| Trace-Globals | Procedure may output Market, EMarketplace, and |
| | Scenario settings to Lo Trace in CSV format |
| Import-Data | Market level procedure may import data for specific |
| | businesses (vs. generating automatically). Basically, may |
| | be a control loop to read a data record, determine type |
| | (Buyer, Seller, Trader), create the relevant instances, |
| | invoke Load-Member-Data to transfer relevant data, and |
| | update counters. |
| | Method also may import data characterizing EMarket- |
| | places and Scenarios from the Repository |
| Initialize- | May import user-specified data for businesses operating |
| Market | in the given Market |
| | May set up Market-specific Graphic Displays (calls |
| | Setup-Graph to create and initialize Plot Window, |
| | Initializes Display-Window and monitor controls for the |
| | given Market) |
| | May create Market model entities (Buyers, Sellers, |
| | Traders, EMarketplaces) |
| | May perform rule-based error checking on parameter |
| | values to ensure model and scenario consistency |
| | May initialize statistical generators (e.g., normalization |
| | factors, means) |
| | May initialize Buyers, Sellers, Traders via Setup-Market- |
| | Member |
| | May initialize EMarketplaces, via Setup-EMarketplace |
| | May normalize Market-Share values for Buyers, Sellers, |
| | Traders, via Normalize-Market-Share |
| | May invoke Allocate-Liquidity method of EMarketplaces |
| | to generate the initial trading commitments, by member |
| | populations Buyer, Seller, Trader |
| Run- | May be control loop for Dynamic Simulation at the |
| EMarketplaces | Market Level |
| | May check error flags |
| | May invoke Run-EMarketplace on EMarketplaces (which |
| | carry out behavior models for simulated trading and other |
| | EMarketplace-specific services. |
| | If the number of cycles matches Market-Update-Period, |
| | then may invoke Update-Market to apply population |
| | changes reflecting market-level evolution over time |
| Update-Market | May control periodic updates of overall market |
| | May compute pro-rating factor for weighting annual rates |
| | as function of fraction of a year represented by Market- |
| | Update-Period |
| | May eliminate (purge) specified number of businesses |
| | (determined at random, first by type (Buyer, Seller, |
| | Trader), and then from the relevant populations, and may |
| | update population counters |
| | May merge specified number existing players of a given |
| | type into other players, (determined at random, first by |
| | type (Buyer, Seller, Trader) and then from the relevant |
| | populations and updates population counters, adding |
| | relevant statistics from the acquired into the member |
| | attributes for the acquirer, eliminating the acquired |
| | companies and updating population counters |
| | May create specified number of new businesses |
| | (determined at random by type of Buyer, Seller, and |
| | Trader). May create using original statistical generation |
| | functions, calling Setup-Market-Member and updating |
| | population counters |
| | May reset global normalization factors and reaccumulate |
| | them over the market populations resulting from the |
| | Market changes |
| | May renormalize market shares and allocate-liquidity |
| | across Buyer, Seller, and Trader populations |
| | May log resulting business entities |
| Setup-Graph | May prepare Plot Window |
| Graph-It | May be invoked at the end of every cycle to plot |
| | aggregate EMarketplace transactions and dollars traded |
| | for all EMarketplaces, extending existing lines plotting |
| | results from previous trading cycles. |
| Print- | May print summary of EMarketplace statistics for all |
| EMarketplaces | EMarketplaces in the Market |

TABLE 9
Exemplary Behaviors for EMarketplaces

| Procedural | |
|---|---|
| Method | Description |
| Color-It | May initialize color assignment of pixel icon representing |
| | Buyer, Seller, Trader in Display Window |
| Determine- | Case Statement may return Role string (e.g., “Buyer”) for |
| Breed | numeric code representing class type |
| Setup- | May initialize member attributes for newly-created |
| EMarketplace | EMarketplaces. (May be generated statistically in the |
| | future using Determine-Market-Share and Normalize- |
| | Market-Share or imported via Load-Member-Data). |
| | May zero EMarketplace statistics accumulators |
| Initialize- | May zero EMarketplaces, which consist primarily of |
| Market- | member attributes that act as statistics accumulators |
| Member | |
| Run- | May be Primary Control loop for EMarketplace updates |
| EMarketplace | May invoke behavioral model (or models) to carry out |
| | allocated transactions. Algorithm may assign Traders to |
| | make their allocated buys first (e.g., using Make- |
| | Demand-Trades), and then may invoke Buyers to make |
| | their allocated buys. |
| | May log state of all Buyers, Sellers, and Traders in |
| | EMarketplace |
| | If the number of cycles matches setting Period-To- |
| | Evaluate, then may: |
| | Perform error checking on decision-related GUI slide |
| | controls for consistency |
| | Invoke Update-Players to serially ask all Buyers, Sellers, |
| | and Traders to review their participation in |
| | EMarketplaces based on experience and EMarketplace |
| | status |
| | Log state of all Buyers, Sellers, and Traders |
| | Finally, EMarketplace also may update itself, using |
| | Compute-EMarketplace-Liguidity and Update- |
| | EMarketplace-Status |
| Update- | EMarketplace-level control procedure that may |
| Players | periodically drive Businesses to reassess their |
| | participation (at Period-to-Evaluate number of cycles) |
| | Buyers, Sellers, and Traders to Update-Supply/Demand/ |
| | Trader-Participation. |
| Pick-Targets | For relevant type (Buyer, Seller, Trader), EMarketplace |
| | may retrieve its current members and pick a subset of |
| | elements, at random of size |
| | Number-to-Pick (representing Nmbr-Charter-Buyers/ |
| | Sellers/Traders). |
| | May be used by Allocate-Supply/Demand/Trader- |
| | Liquidity |
| Pick-Targets- | Auxiliary method to Pick-Targets. Once Pick-Targets |
| Aux | selects candidate trading partners, Pick-Targets-Aux |
| | applies business rules to ensure that selection does not |
| | violate consistency constraints (e.g., fewer members than |
| | requested. |
| Allocate- | May perform initial error checking on Error flag and on |
| Liquidity | parameter settings concerning Charter Buyers, Sellers, |
| | Traders to given EMarketplaces to ensure model and |
| | scenario consistency |
| | May compute list of target populations (Buyers, Sellers, |
| | Traders) from Charter Members (generated and imported) |
| | and invokes Allocate-Supply-Liquidity on Sellers, and |
| | Allocate-Trader-Liquidity on Traders |
| | May compute resulting aggregate liquidity for |
| | EMarketplaces by invoking Compute-EMarketplace- |
| | Liquidity |
| Compute- | May compute aggregate supply and demand liquidity for |
| EMarketplace- | a given EMarketplace by aggregating Buy- and Sell- |
| Liquidity | Transactions-Allocated-to-EMarketplace values for |
| | members. Also may compute Market-Share (average of |
| | supply and demand liquidity), display position, and color |
| | (via Color-It) |
| Update- | May update EMarketplace accumulators periodically, |
| EMarketplace- | after Update-Player method calls, for Transactions-Buy |
| Status | and Sell, Money-EMarketplaced-Buy and Sell, |
| | Transaction-Failures, and Buy- and Sell-Transactions- |
| | Allocated-to-EMarketplaces |

TABLE 10
Exemplary Behaviors for Businesses (Buyer, Seller, Trader)

| Procedural | |
|---|---|
| Method | Description |
| Color-It | May initialize color assignment of pixel icon representing |
| | Buyer, Seller, Trader in Display Window |
| Print-State | May writes the attribute values for a given Business |
| | (Buyer, Seller, or Trader) to the Log Trace Window, in |
| | CSV format |
| Determine- | Case Statement may return Role string (e.g., “Buyer”) for |
| Breed | numeric code representing class type |
| Load-Member- | May take an array of user-supplied data characterizing a |
| Data | business and populates the relevant attributes of a newly- |
| | created instance of Buyer, Seller, or Trader |
| Initialize- | May initialize member attributes for newly-created |
| Market- | Buyers, Sellers, and Traders. If instances are imported |
| Member | rather than generated, algorithm may filter attributes |
| | supplied from imported specification, preventing |
| | overwriting by default value assignments. May use Case |
| | Statement for Buyer, Seller, and Trader specific value |
| | assignments such as color and display position. May call |
| | Determine-Market-Share (or uses imported values) and |
| | accumulate aggregate Market-Share by Player type in |
| | global variable for use by Normalize-Market-Share |
| Determine- | May set Business Market-Share attribute, initially using a |
| Market-Share | uni-modal random Gaussian distribution number |
| | generator as function of mean and standard deviation. In |
| | certain embodiments, this may be overridden with other |
| | generated or user-specified functions (e.g., Poisson |
| | distribution for small markets, with 30 or fewer |
| | businesses) |
| Normalize- | May adjust Market-Share values to approximately 100. |
| Market-Share | May assume Traders sell what they buy, so Mkt-Shares |
| | may first be normalized to 100% for Buyers, Sellers, and |
| | Traders individually, and then be renormalized to reflect |
| | that Traders cause Products to be bought or sold twice. |
| | e.g., MktShare Buyer * 1/I1 + % purchases by Traders |
| Allocate- | May assign liquidity (buy-commitment and trust) to |
| Demand- | Buyers (and may adjust display position). First-Time? |
| Liquidity | flag may distinguish initial calls (true) from Determine- |
| | Membership-Changes and Update-Market calls. In the |
| | case of initial calls, sell-commitment may be supplied to |
| | a subset of Buyers (the Array of Targets) in the market |
| | (namely the charter Buyers) based on a random |
| | distribution function. Then all instances may be assigned |
| | Buy-Transactions-Allocated-to-EMarketplaCe values |
| | computed from Total Transactions supported by this |
| | market and buy- commitment, Trust, and color values. |
| Allocate- | May assign liquidity (sell-commitment and trust) to |
| Supply- | Sellers (and adjusts display position. First-Time? flag |
| Liquidity | may distinguish initial calls (true) from Determine- |
| | Membership-Changes and Update-Market call. In the |
| | case of initial calls, sell-commitment may be supplied to |
| | a subset of Sellers (the Array of Targets) in the market |
| | (namely the charter Sellers) based on a random |
| | distribution function. Then all instances may be assigned |
| | Sell-Transactions-Allocated-to-EMarketPlace values |
| | computed from Total Transactions supported by this |
| | market and buy-commitment, Trust, and color values |
| Allocate- | May assign liquidity (buy-, sell-commitment and trust) to |
| Trader- | Traders (and adjusts display position. First-Time? flag |
| Liquidity | may distinguish initial calls (true) from Determine- |
| | Membership-Changes and Update-Market call. In the |
| | case of initial calls, buy- and sell-commitments may be |
| | supplied to a subset of Traders (the Array of Targets) in |
| | the market (namely the charter Traders) based on a |
| | random distribution function. Then all instances may be |
| | assigned Buy- and Sell-Transactions-Allocated-to- |
| | EMarketplace values computed from Total Transactions |
| | supported by this market and buy-commitment, Trust, |
| | and color values |
| Adjust- | May adjust liquidity (Buy-Commitment, Buy- |
| Demand- | Transactions-Allocated-to-EMarketplace trust, color, |
| Liquidity | display-position) based on Percent (specified from |
| | business rule in Decide-Continuation-Behavior). May |
| | handle extrema cases (where parameter would result in |
| | values < 0% or > 100%) and also may round up rather |
| | than truncate fractional values of Buy-Transactions when |
| | initial values are under 10, to ensure that change takes |
| | place |
| Adjust-Supply- | May adjust liquidity (Sell-Commitment, Sell- |
| Liquidity | Transactions-Allocated-to-EMarketplace trust, color, |
| | display-position) based on Percent (specified from |
| | business rule in Decide-Continuation-Behavior). May |
| | handle extrema cases (where parameter would result in |
| | values < 0% or > 100%) and may also round up rather |
| | than truncate fractional values of Sell-Transactions when |
| | initial values are under 10, to ensure that change takes |
| | place |
| Adjust-Trader- | May adjust liquidity (Buy- and Sell-Commitment, Buy- |
| Liquidity | and Sell-Transactions-Allocated-to-EMarketplace trust, |
| | color, display-position) based on Percent (specified |
| | from business rule in Decide-Continuation-Behavior). |
| | May handle extrema cases (where parameter would result |
| | in values < 0% or > 100%) and also may round up rather |
| | than truncate fractional values of Buy- and Sell- |
| | Transactions when initial values are under 10, to ensure |
| | that change takes place |
| Renormalize- | Method may handle periodic readjustment of Market- |
| Market-Share | Share for Buyers, Sellers, and Traders reflecting market- |
| | level changes to the market population and thence |
| | EMarketplaces caused by Update-Market), due to |
| | business closures, formations, M&A, market growth (or |
| | decline), or new regulatory constraints |
| Update-Buyer- | May control invocation of Decide-Continuation-Behavior |
| Participation | or Determine-Membership-Changes depending on |
| Update-Seller- | whether business currently belongs to the given |
| Participation | EMarketplace or not |
| Update-Trader- | |
| Participation | |
| Update-Tenure | May be called from Run-EMarketplaces. May update the |
| | number of days of continuous membership in an |
| | EMarketplace by buyer, seller, or trader |
| Update-Trust | May be called from Adjust-Demand/Supply/Trader- |
| | Liquidity. May update Trust that member has in |
| | EMarketplace as function of liquidity commitments to the |
| | EMarketplace and tenure. |
| Sigmoid | May be used in Determine-Membership-Changes to |
| | model network effects of liquidity: may model a simple |
| | sigmoid function that gives disproportionate weighting to |
| | liquidity. Result may be a weighting factor that is |
| | insensitive (changes little) when EMarketplace has low or |
| | very high market share but very sensitive/steep rise in |
| | middle |
| Set-Partners | May apply the inputs to select suitable trading partners |
| | (combination of buyers and traders or sellers and traders, |
| | as dictated by the integer arguements and the settings of |
| | Traders-Trade-With-Thenselves? And Percentage-Sold- |
| | Thru-Traders |
| Remove- | If Corpse is currently a trading partner, may remove it |
| Partner | from the array Abuyer-partners, Aseller-partners, as |
| | appropriate. If not currently a trading partner does |
| | nothing. Seller? Is TRUE if business is a seller or trader |
| | in buyer mode. |
| Make- | May be business rule for trading under a standard |
| Demand- | Aggregator or Catalog-based model, in which buyers (or |
| Trades | traders in buying mode) initiate transactions against |
| | sellers (or traders in sell mode) to purchase goods or |
| | services at a fixed price. Procedure may go through |
| | allocated purchases for a given business per unit trading |
| | time |
| Determine- | May invoke modular rules (typically Case statements for |
| Membership- | Buyer, Seller, Trader) that set up decision criteria for |
| Changes | non-members (ex-members are handled as separate cases) |
| | for joining particular EMarketplaces. An example rule |
| | may compute a value by multiplying weighting factors by |
| | the Liquidity sigmoid, content, commerce and |
| | community, as set in the Scenario. Based on the value |
| | computing, the rule may determine whether the party |
| | joins or remains out of the EMarketplace. If the party |
| | joins, the appropriate Allocate-Liquidity (Supply, |
| | Demand, Trader) may be called with the First-Time? |
| | flag set false and a null set of Targets |
| Decide- | May invoke modular rules (typically Case statements for |
| Continuation- | Buyer, Seller, Trader) that set up decision criteria for |
| Behavior | existing members to change their level of participation in |
| | particular EMarketplaces. An example rule may compute |
| | a value by comparing the transactions that succeeded |
| | against the quota of Transactions-Allocated-To- |
| | EMarketPlace. Typically, based on a set of ranges, the |
| | outcome may be to invoke Adjust-Demand-Liquidity |
| | with a percentage change, reflecting Extreme |
| | Dissatisfaction (and withdrawal from the EMarketplace), |
| | Mild Dissatisfaction (leading to some percentage |
| | decrease in Transactions-Allocated), Satisfied (leading to |
| | no change in participation), and Highly-Satisfied (leading |
| | to some percentage increase in Transactions-Allocated |

### Analytics

The simulation engine generates a text-based log trace that records all of the primary behaviors and key performance metrics computed for LinesOfBusiness, EMarketplaces, and Markets at the end of each simulation cycle 130. The Simulator Management Interface provides controls to save the trace to an ASCII file, in a standardized (CSV) format.

One embodiment of the present invention incorporates a software component that may be implemented as an add-in module to a third party and/or commercial spreadsheet application program, e.g., Microsoft™ Excel. Using the add-in's GUI, the analyst can use Excel to import log trace files and generate reports that sort, filter, and reduce the simulator output into summary graphs and tables that enable analysts to assess the outcomes of simulated decision options.

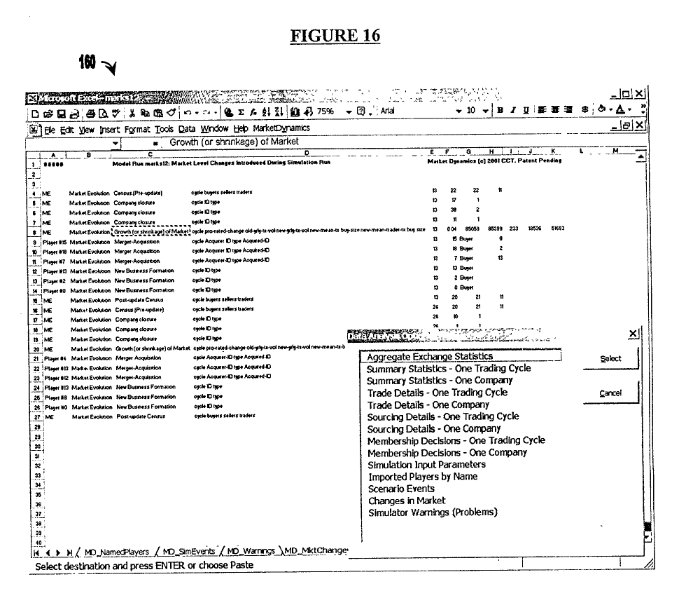

FIG. 16 illustrates an exemplary report 160 that summarizes the results of Update Market behavior during one simulation run. The report enumerates the pro-rated changes to the Market caused by simulated company closures, Market transaction Growth, new LineOfBusiness formation, and M&A transactions. The overlay window illustrates the analytic reports that the B2B EMarketplace embodiment supports. Users can study aggregate EMarketplace and Market statistics; assess utilization statistics for EMarketplace Service Offerings, such as Sourcing and Trading; review model values, including players-by-name; study simulated Market changes or simulated LineOfBusiness decision behaviors. In the present embodiment, many reports can be generated from dual perspectives: summarizing all EMarketplace data for a particular cycle or summarizing all data relating to a selecting LineOfBusiness across the complete simulation run. Businesses facing strategic decisions need to evaluate them from both aggregate and parochial viewpoints. In the case of a B2B marketplace build/join decision, the aggregate view provides insight into the overall competitiveness of particular EMarketplaces, while the fine-grained view provides insight into the risks and benefits of participation for a single LineOfBusiness.

### Delivery Model

It is understood that the toolset of the present invention may be embodied as one or a family of shrink-wrapped software products. In individual product embodiments, the toolset may embed substantial knowledge about specific industrial markets, such as ferrous metals, specialty chemicals, automobiles, and professional services. In individual product embodiments, the toolset may also embed substantial knowledge about specific kinds of business decisions and domain model extensions specific to those decisions, such as participation in B2B marketplaces, due diligence reviews of merger and acquisition deals, and evaluating options to build new business lines or production facilities.

It is also contemplated that the toolset of the present invention may be embodied in a business method employing the toolset. Much of the knowledge in individual embodiments may be captured in declarative form in domain model elements and scenario data. Many elements may also be captured in business rules and software procedures that may require direct manipulation by software developers or other individuals. Proper use of the toolset presupposes some understanding of the modeling framework, as well as knowledge of statistics, simulation techniques, and the implementation of these techniques specific to the present invention. Thus, the toolset, in some embodiments of the invention, may require expert knowledge to configure, adapt, and to interpret its results.

Accordingly, a consulting service employing the toolset may be used to help clients of the service (1) extend the modeling framework with additional elements, attributes and relationships required to capture key domain decision factors; (2) populate the (extended) decision contexts and scenarios with data, assumptions, and custom behavioral rules; (3) define the strategic choices facing the client; (4) populate the decision contexts and scenarios necessary to explore the strategic choices and understand the interplay of decision factors in terms of a set of possible simulated futures; (5) perform the required simulations (on consulting service computers); and (7) extract the execution traces and perform initial data collation, analysis, and reports. The deliverables for an engagement may consist of hardcopy and/or machine-readable softcopy versions of: (1) the specifications of strategic options and decision factors; (2) the descriptions of models and scenarios; (3) the spreadsheet-based execution data and utility macros; (4) all generated analytic reports; and (5) recommendations based on these work products.

The toolset may also be embodied in a hybrid consulting/self-service offering delivered via the application service provider (ASP) model. The ASP offering may be organized somewhat differently from the consulting service wherein the ASP will: (1) perform the front-end strategic consulting, requirements analysis, model implementation and simulator configuration as described above; (2) provide a pre-configured version of the client's models and scenarios over the Internet through a browser-based interface to consulting service servers; (3) provide training to client “power-users” (e.g., strategic planners with statistics backgrounds), enabling them to reconfigure the models, develop new scenarios, execute simulations, and perform data analyses autonomously, without direct assistance from the consulting service; and (4) provide additional programming or tool enhancements, as needed to support client requirements. These customizations may be provided as needed, via follow-on consulting services.

It is contemplated that the present invention may have utility in the context of system integrators and/or other consulting organizations, including entities that may provide scalable channels to prospective clients. Embodiments of the invention may therefore be integrated with additional capabilities to design, construct, and host new Internet marketplaces, and embodiments of the invention may be designed so as to facilitate integration with existing marketplaces, thereby providing complete end-to-end solution support.

### Potential Target Market

It is contemplated that the invention may have utility in the context of a wide variety of businesses that face strategic business decisions over their lifetimes. In particular, the target market for one embodiment of the invention comprises companies facing B2B marketplace channel decisions including, e.g., (1) businesses that are planning to build independent net markets; (2) businesses that are planning to build private marketplaces; (3) business consortia that are planning to build industry-sponsored B2B EMarketplaces; (4) businesses or consortia already operating Internet-enabled marketplaces, but who are planning significant enhancements or who want to assess the competitive landscape; (5) businesses investigating mergers or acquisitions with existing Internet-enabled marketplaces; (6) companies that intend to join rather than buy or build EMarketplaces; (7) consultants & system integrators that design, build, and host B2B EMarketplaces for end-user clients; and (8) venture capitalists, angel investors, and other parties performing due diligence on Internet-enabled marketplaces.

It is contemplated that the present invention may have utility in the context of other kinds of strategic business decisions, including mergers and acquisitions, decisions to build new production capacity or to close down existing facilities; decisions to develop new products or lines of business, or to discontinue existing ones, and so on. Markets for such applications will include businesses and the professional service firms that help evaluate and execute such plans, including analysts, consultants, attorneys, accountants, and investment bankers. Finally, it is contemplated that the present invention may have utility in the context of other kinds of complex strategic decisions involving large number of interacting, independent players in non-business domains. Examples include decisions regarding military strategy, implications of legislative or environment programs, healthcare, and so on.

### Alternative Embodiments

Those skilled in the art will recognize that embodiments of the invention, as described hereinabove, may be embodied in hardware, software, and/or a combination of hardware and software. Hardware implementations may include servers and their various components, and the processes and algorithms described hereinabove may be separate components or may be integrated into other components described above. Likewise, the processes described herein may be combined with other processes not described herein and may run on common, shared, or separate machines, and as integrated or separate software modules. Hardware implementations may include appropriate networking functionality, e.g., the present invention may use the public Internet and Internet compatible HTTP and TCP/IP or UDP/IP protocols for network interconnections, or any other network or combination of networks.

It will be appreciated by those skilled in the art that, although the functional components of the above described embodiments of the system of the present invention may be embodied as one or more distributed computer program processes, data structures, dictionaries or other stored data on one or more conventional general purpose computers (e.g., IBM-compatible, Apple Macintosh, and/or RISC microprocessor-based computers), mainframes, minicomputers, conventional telecommunications (e.g., modem, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention.

The invention as described hereinabove may be embodied in one or more computers residing on one or more server systems, and input/output access to the invention may comprise appropriate hardware and software (e.g., personal and/or mainframe computers provisioned with Internet wide area network communications hardware and software (e.g., CQI-based, FTP, Netscape Navigator™ or Microsoft™ Internet Explorer™ HTML Internet browser software, and/or direct real-time TCP/IP interfaces accessing real-time TCP/IP sockets) for permitting human users to send and receive data, or to allow unattended execution of various operations of the invention, in real-time and/or batch-type transactions and/or at user-selectable intervals. Likewise, it is contemplated that servers utilized in an embodiment of the present invention may be remote Internet-based servers accessible through conventional communications channels (e.g., conventional telecommunications, broadband communications, wireless communications) using conventional browser software (e.g., Netscape Navigator™0 or Microsoft™ Internet Explorer™), and that the present invention should be appropriately adapted to include such communication functionality. Additionally, those skilled in the art will recognize that the various components of the system of the present invention can be remote from one another, and may further comprise appropriate communications hardware/software and/or LAN/WAN hardware and/or software to accomplish the functionality herein described. Alternatively, a system consistent with the present invention may operate completely within a single machine, e.g., a mainframe computer, and not as part of a network.

Moreover, each of the functional components of the present invention may be embodied as one or more distributed computer program processes running on one or more conventional general purpose computers networked together by conventional networking hardware and software. Each of these functional components may be embodied by running distributed computer program processes (e.g., generated using “full-scale” relational database engines such as IBM DB2™, Microsoft™ SQL Server™, Sybase SQL Server™, or Oracle 8.0™ database managers, and/or a JDBC interface to link to such databases) on networked computer systems (e.g., comprising mainframe and/or symmetrically or massively parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software.

Elements of the invention may be server-based and may reside on hardware supporting an operating system such as Microsoft™ Windows NT/2000™ or UNIX. Clients may include computers with windowed or non-windowed operating systems, e.g., a PC that supports Apple Macintosh™, Microsoft™ Windows 95/98/NT/ME/2000™, or MS-DOS™, a UNIX Motif workstation platform, a Palm™, Windows CE™-based or other handheld computer, a network- or web-enabled mobile telephone or similar device, or any other computer capable of TCP/IP or other network-based interaction. Communications media utilized in an embodiment of the invention may be a wired or wireless network, or a combination thereof.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as is necessary to permit these functional components to achieve the stated functionalities. In this alternative configuration, either a relational database or a non-relational flat file “table”, or a combination of both, may be included in at least one of the networked personal computers to represent at least portions of data stored by a system consistent with the present invention. These personal computers may run, e.g., Unix, Microsoft™ Windows NT/2000/XP™ or Windows 95/98/ME™ operating system. The aforesaid functional components of a system consistent with the present invention may also comprise a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

As those in the art will recognize, possible embodiments of the invention may include one- or two-way data encryption and/or digital certification for data being input and output, to provide security to data during transfer. Further embodiments may comprise security means in the including one or more of the following: password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other security measures known in the art. Such security measures may be implemented in one or more processes of the invention.

Source code may be written in an object-oriented or non-object-oriented programming language using relational or flat-file databases and may include the use of other programming languages, e.g., C++, Java, HTML, Perl, UNIX shell scripting, assembly language, Fortran, Pascal, Visual Basic, and QuickBasic. It is noted that the screen displays illustrated herein at FIGS. 12-15 are provided by way of example only and are not to be construed as limiting the invention or any component thereof to the exemplary embodiments illustrated therein.

Furthermore, it is contemplated that the system and method described herein may be implemented as part of a business method, wherein a system constructed in accordance with the invention as described herein may be used in a business method wherein payment may be received from users or other entities that may benefit from the advantages of the stated method and/or system. Such users may pay for the use of the invention based on the number of files, messages, transactions processed, or other units of data sent or received or processed, or algorithms or processes run, based on bandwidth used, on a periodic (weekly, monthly, yearly) or per-use basis, or in a number of other ways consistent with the invention, as will be appreciated by those skilled in the art.

Finally, it should also be appreciated from the outset that one or more of the functional components may alternatively be constructed out of custom, dedicated electronic hardware and/or software and/or human actors, without departing from the present invention. Thus, the present invention is intended to cover all such alternatives, modifications, and equivalents as may be included within the spirit and broad scope of the invention.

What is claimed is:

1. A method for supporting strategic business decision-making comprising:
(a) prompting a user for entry of a plurality of input data corresponding to a business decision modeling framework, said input data comprising at least one decision option comprising at least one assumption describing at least one business entity, said assumption comprising at least one attribute, trend, relationship, and/or projected behavior;
(b) receiving said input data;
(c) simulating a plurality of outcomes under a plurality of scenarios over a period of time based on said input data; and
(d) analyzing said plurality of outcomes.

2. A method as claimed in claim 1, further comprising receiving at least one update to the input data supplied in said step (a), said update derived from at least one external source and/or generated from said steps (c) and/or (d), and repeating said step (c) and/or (d) based, at least in part, on said updated input data.

3. A method as claimed in claim 2, wherein said updated input data comprises at least one type of feedback from an external source, said external source selected from the group consisting of: measured status of at least one business initiative to carry out an adopted decision strategy; market response to said at least one business initiative; an observed change in the economy and/or market over time; a competitive response to at least one said business initiative, embodied in a new rival business model; improved knowledge about decision factors; and improved knowledge about at least one behavior of said at least one said business entity.

4. A method as claimed in claim 1, wherein said input data further comprises a description of at least one economic environment and/or context.

5. A method as claimed in claim 1, further comprising receiving input data corresponding to at least one decision model framework selected from the group consisting of: macro-economic conditions at a given time; at least one vertical or horizontal market and/or at least one business operating within said vertical or horizontal market, and/or characteristics and/or relationships of said market and/or business; at least one good or service traded within said markets; at least one operating and/or proposed online Business-to-Business (B2B) marketplace; and at least one “what-if” scenario based on at least one assumptive trend, condition, behavior of a business entity, and/or event.

6. A method as claimed in claim 1, wherein at least one said projected behavior comprises data selected from the group consisting of: a demographic and/or relevant qualitative macro- and/or micro-economic characteristic of a target vertical industry and/or horizontal market and/or businesses that participates in said market; a macro-economic factor representing a domestic and/or global economic context in which said vertical industry and/or horizontal market functions; a factor depicting a structural and/or behavioral change occurring in an industrial market over time; an existing and/or proposed Internet-enabled marketplace and/or a service, business model, relative position, and/or competitive difference corresponding to said marketplace; an assumption that represents an alternative scenario for how said marketplace will evolve over time and/or alter a parent markets of and/or a business that participates in said marketplace; and historical market-, marketplace-, and/or business-specific transactional data.

7. A method as claimed in claim 1, wherein said projected behavior is adaptive and/or comprises at least one nonlinear trend.

8. A method as claimed in claim 1, wherein at least one of said plurality of scenarios comprises event data, said event data regarding at least one event capable of disrupting, affecting, and/or altering the economic environment and/or the operation of at least one said business entity, said event data comprising a projected time of said event and/or a description of the nature of said event and/or the effects of said event.

9. A method as claimed in claim 1, wherein said event data is organized into episode data, said episode data comprising a sequence of causally related events.

10. A method as claimed in claim 1, wherein at least one of said plurality of scenarios comprises at least one trend and/or assumption about projected behavior of at least one said business entity.

11. A method as claimed in claim 1, wherein said at least one business entity is a business entity selected from the group consisting of: an economy, a market, a company, a line of business within a company, a B2B marketplace and an item of commercial trade comprising a product or service.

12. A method as claimed in claim 1, wherein said at least one attribute, trend, relationship, and/or projected behavior and/or event comprises at least one source of change selected from the group consisting of: a macro-economic trend; a market-specific trend; an interaction between companies; a company's decision to pursue a strategic action; and a company's decision to alter its behavior and/or business activities based on its perception of economies, markets and/or B2B marketplaces.

13. A method as claimed in claim 1, wherein said step (c) is performed by a simulation method that treats each source of change at a particular instant of time as a discrete factor that can potentially impact at least one said business entity.

14. A method as claimed in claim 1, wherein said step (c) is performed by a simulation method that reflects a mass variation of at least one characteristic across a population of modeled business entities using at least one statistical projection of characteristic values across said population.

15. A method as claimed in claim 1, wherein said step (c) is performed by a simulation method that treats at least one population of model markets and/or companies and/or business units of said companies, and/or B2B marketplaces generated from said input data as independent active entities, capable of independent and/or autonomous behaviors, consistent with the principles of economics.

16. A method as claimed in claim 1, further comprising outputting to a user and/or writing to a storage medium at least one of said plurality of outcomes and/or at least a portion of said input data.

17. A method as claimed in claim 16, further comprising permitting a user to select and/or modify and/or retrieve and/or save to a storage medium at least one of said plurality of outcomes and/or at least a portion of said input data.

18. A method as claimed in claim 1, wherein said step (d) further comprises outputting data generated in said step (c) to a user, wherein said outputted data is selected from the group consisting of: aggregate statistics corresponding to a model and its population, derived from their simulated business interactions; detailed statistics corresponding to at least one modeled company's simulated business activities; data corresponding to a change that takes place over the course of simulation; data corresponding to at least one simulated behavioral decision of at least one modeled company; and at least a portion of said input data.

19. A method as claimed in claim 1, wherein said step (d) further comprises outputting data generated in said step (c) to a user, wherein said data is in an ASCII and/or comma delimited file and/or in a standardized format and/or said data is self-descriptive.

20. A method as claimed in claim 1, wherein said step (d) further comprises:
outputting at least one said outcome viewed from the perspective of a first said entity; and
outputting at least one said outcome viewed from the perspective of a second said entity.

21. A system for supporting strategic business decision-making comprising:
an object model wherein each said object comprises data and a behavior module; said data comprising attributes of said object; said behavior module comprising instructions for manipulating said attributes of said object;
a database for storing model data and/or scenario data, said scenario data corresponding to a plurality of scenarios; and
a simulation engine, said simulation engine manipulating said object model and said scenario data to generate a plurality of projected outcomes to decision options.

22. A system as claimed in claim 2l, wherein each said object corresponds to an actor or a business entity.

23. A system as claimed in claim 21, further comprising a user interface adapted to permit viewing and/or modification and/or deletion of at least one element selected from the group consisting of: said object model, said object, said object data, the behavior of said object, said database, said scenario data, and parameters corresponding to said simulation engine.

24. A system as claimed in claim 21, further comprising an analysis engine adapted to analyze said plurality of outcomes under said plurality of scenarios and/or to receive raw data from said simulation engine and sort and/or filter and/or transform and/or aggregate and/or analyze said raw data.

25. A system as claimed in claim 24, wherein said analysis engine is further adapted to output at least one report to a user.

26. A system as claimed in claim 25, wherein said at least one report is selected from the group consisting of: aggregate statistics corresponding to a model and its population, derived from their simulated business interactions; detailed statistics corresponding to at least one company's simulated business activities; data corresponding to a change that takes place over the course of simulation; and data corresponding to at least one simulated behavioral decision of at least one company.

27. A system as claimed in claim 21, wherein said user interface enables users to select, create, add to, delete from, modify, and/or save said model objects.

28. A system as claimed in claim 21, wherein said user interface enables users to select and load models and scenarios; initiate, pause, resume, and/or halt said simulation engine; monitor ongoing simulated model behaviors; and/or save simulation run results.

29. A system as claimed in claim 21, wherein said simulation model is further adapted to output at least one said outcome viewed from the perspective of at least two entities.

30. A system as claimed in claim 21, wherein said database is accessible for reading and/or writing via structured query language (SQL) and/or extensible markup language query language (XQL).

31. A system as claimed in claim 21, further comprising a module adapted to extract the metadata structure of said object model and generate instructions for constructing data definition instructions of said database for storing said model data.

32. A system as claimed in claim 31, further comprising a module adapted to load said data definition instructions to create said database.

33. A system as claimed in claim 31, further comprising an editor module adapted to extend and/or customize at least one of said object metadata from said model.

34. A system as claimed in claim 33, further comprising a module for storing said object metadata in said database.

35. A system as claimed in claim 23, wherein said user interface is adapted to permit display and/or modification of at least one said object by manipulating said metadata.

36. A system as claimed in claim 21, further comprising a module for adding new attributes to said objects.

37. A system as claimed in claim 21, wherein a plurality of business entity behaviors is represented as a plurality of behavioral and/or decision rules.

38. A system as claimed in claim 37, wherein at least one said behavioral and/or decision rule is adaptive and/or comprises at least one nonlinear trend.

39. A system as claimed in claim 23, further comprising at least one parser adapted to receive behavioral data from said user interface, wherein said parser and said user interface are adapted to permit a user to define a plurality of behaviors for model entities and/or events, said parser being further adapted to convert said defined behaviors into behavioral rule modules.

40. A system as claimed in claim 21, further comprising an export module adapted to export output data generated by said simulation model, wherein said data is in an ASCII and/or comma delimited file and/or in a standardized format and/or said data is self-descriptive.

41. A simulation engine for supporting strategic business decision-making comprising:
a parallel discrete event simulation shell comprising a module adapted to perform at least one distributed agent-based technique for simulating causal and intentional behaviors across populations of active model entities interacting with one another and their environment, a rule-based simulation engine and a Monte Carlo programming module, said Monte Carlo programming module being adapted to perform stochastic distributions of values over populations of market entities.

42. A simulation engine as claimed in claim 41, wherein said parallel discrete event simulation shell is adapted to receive event data, said event data regarding at least one event capable of disrupting, affecting, and/or altering the economic environment and/or the operation of at least one said market entity, said event data comprising a projected time of said event and/or a description of the nature of said event and/or the effects of said event.

43. A method for managing strategic decision outcomes comprising:
receiving decision option data;
projecting outcomes of said decision option data under a plurality of scenarios; and
analyzing said outcomes, thereby providing decision outcome data;
wherein said decision outcome data represents at least one consequence corresponding to said decision option data, and wherein said at least one consequence comprises at least one positive consequence and/or reward corresponding to said decision option data.

44. A method as claimed in claim 43, wherein said at least one consequence comprises at least one negative consequence and/or risk corresponding to said decision option data.

45. A method as claimed in claim 43, wherein said decision outcome data further represents at least one interrelation between at least two said consequences.

46. A method as claimed in claim 43, wherein said at least one said scenario comprises event data.

47. A method for supporting strategic business decision-making comprising:
analyzing a plurality of outcomes of decision option data projected under a plurality of scenarios;
wherein said decision outcome data represents at least one consequence corresponding to said decision option data, and wherein said at least one consequence comprises at least one positive consequence and/or reward corresponding to said decision option data.

48. A method for supporting decision-making comprising:
(a) prompting a user for entry of a plurality of input data corresponding to a decision modeling framework, said input data comprising at least one decision option comprising at least one assumption describing at least one actor, said assumption comprising at least one attribute, trend, relationship, and/or projected behavior;
(b) receiving said input data;
(c) simulating a plurality of outcomes under a plurality of scenarios over a period of time based on said input data; and
(d) analyzing said plurality of outcomes.

49. A method as claimed in claim 48, further comprising receiving at least one update to the input data supplied in said step (a), said update derived from at least one external source and/or generated from said steps (c) and/or (d), and repeating said step (c) and/or (d) based, at least in part, on said updated input data.

50. A method as claimed in claim 49, wherein said updated input data comprises at least one type of feedback from an external source, said external source selected from the group consisting of: measured status of at least one initiative to carry out an adopted decision; response to said at least one initiative by other actors in said actor's decision environment; an observed change in said decision environment over time; improved knowledge about decision factors; and improved knowledge about at least one behavior of said at least one said actor.

51. A method as claimed in claim 48, wherein said input data further comprises a description of at least one environment and/or decision context, said context comprising at least one condition selected from the group consisting of: economic, social, political, legislative, military, legal, geographical, demographic, medical, climatological, environmental, and engineering factors.

52. A method as claimed in claim 48, further comprising receiving input data corresponding to at least one decision model framework selected from the group consisting of: conditions of said decision environment at a given time; a characteristic and/or relationship of one of said actors; and at least one “what-if” scenario based on at least one assumptive trend, condition, actor behavior, and/or event.

53. A method as claimed in claim 48, wherein at least one of said plurality of scenarios comprises event data, said event data regarding at least one event capable of disrupting, affecting, and/or altering the decision environment and/or the operation or behavior of at least one said actor, said event data comprising a projected time of said event and/or a description of the nature of said event and/or the effects of said event.

54. A method as claimed in claim 48, wherein said event data is organized into episode data, said episode data comprising a sequence of causally related events.

55. A method as claimed in claim 48, wherein at least one of said plurality of scenarios comprises at least one trend and/or assumption about projected behavior of at least one said actor.

56. A method as claimed in claim 48, wherein said at least one actor is selected from the group consisting of: a single individual, a group of individuals, an institution, and a man-made artifact, device, product or system.

57. A method as claimed in claim 48, wherein said at least one attribute, trend, relationship, and/or projected behavior and/or event comprises at least one source of change selected from the group consisting of: a trend; a decision environment-specific trend; an interaction between actors; an actor's decision to pursue a course of action; and an actor's decision to alter its behavior and/or activities based on its perception of the decision environment and/or other said actors.

58. A method as claimed in claim 48, wherein said step (c) is performed by a simulation method that treats each source of change at a particular instant of time as a discrete factor that can potentially impact at least one said actor.

59. A method as claimed in claim 48, wherein said step (c) is performed by a simulation method that reflects a mass variation of characteristics across a population of modeled actors using at least one statistical projection of characteristic values across said population.

60. A method as claimed in claim 48, wherein said step (c) is performed by a simulation method that treats a population of model decision environments and/or actors as independent active entities, capable of independent and/or autonomous behaviors.

61. A method as claimed in claim 48, further comprising outputting to a user and/or writing to a storage medium at least one of said plurality of outcomes and/or at least a portion of said input data.

62. A method as claimed in claim 61, further comprising permitting a user to select and/or modify and/or retrieve and/or save to a storage medium at least one of said plurality of outcomes and/or at least a portion of said input data.

63. A method as claimed in claim 48, wherein said step (d) further comprises outputting data generated in said step (c) to a user, wherein said outputted data is selected from the group comprising: aggregate statistics corresponding to a model and its population, derived from their simulated interactions among or between actors; detailed statistics corresponding to at least one actor's simulated activities; data corresponding to a change that takes place over the course of simulation; and data corresponding to at least one simulated behavioral decision of at least one actor.
